(19) United States
(12) Patent Application Publication
(10) Pub. No.: US 2004/0108971 A1
(43) Pub. Date: Jun. 10, 2004

(54) Method of and apparatus for viewing an image

(75) Inventors: Jonathan D. Waldern, Los Altos Hills, CA (US); Milan M. Popovich, Leicester (GB); John J. Storey, Wollaton (GB); Stephen F. Sagan, Lexington, MA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(73) Assignee: DigiLens, Inc.

(21) Appl. No.: 10/138,401

(22) Filed: May 3, 2002

Related U.S. Application Data
(63) Continuation of application No. 09/057,461, filed on Apr. 9, 1998, now Pat. No. 6,407,724.

(51) Int. Cl. G09G 5/00

(52) U.S. Cl. 345/8

(57) ABSTRACT

A head mountable apparatus is described for transmitting an image to the user's eye using switchable holographic optical elements. In one embodiment, an optical system is provided that is configured to receive an image provided by an image generator and which forms a light path along which light is transmitted from the image generator to an eye of the user. The optical system includes a first switchable holographic optical element configured to operate in an active state or an inactive state, wherein the first switchable holographic optical element is configured to diffract the image light incident thereon when the first switchable holographic optical element operates in the active state, and wherein the first switchable holographic optical element transmits the image light incident thereon without substantial alteration when the first switchable holographic optical element operates in the inactive state.

### DESCRIPTION OF THE RELEVANT ART

Head mountable display devices are becoming more commonly used with the advent of faster computing systems and smaller display devices. Typically, a head mountable display device transmits an image from an image generator to the eye of a user. Because the device is mounted to the head of the user, the image is only projected to the user, and not to the surroundings. Such devices have become popular for military, industrial and entertainment uses.

Many existing head mountable display devices include an image generating system which is positioned directly in front of the user's eye,. Older head mountable display devices typically used an opaque image generating system. Such an image generating system would prevent the user from observing their surroundings while viewing the image. More recently the use of translucent or transparent image generating systems allows a user to view a portion of their surroundings while also viewing an image produced by the generator. Such systems typically require an image generating system to be placed in front of the user's eye. Such elements tend to make the display devices “front heavy.” These front heavy display devices tend to be uncomfortable for a user of the device. The placement of the image generating system in front of the display device tends to place pressure on the user's head leading to increased fatigue. Many users may find it uncomfortable to wear such devices after a few hours.

In an effort to avoid such problems, some head mountable display devices use an image generator that is offset from the direct field of view of a user. An optical system is then constructed to transfer the image from the image generator to the user's eye. In this manner the weight associated with the image generator and some components of the optical system may be better distributed through the display device and onto the user's head. However, in order to project the image at a user's eye, a number of optical elements must be placed around and in front of the user's eye. These optical elements not only are used to transfer the image to a user's eye, but also help to reduce chromatic aberrations and monochromatic aberrations and distortions, such as astigmatism, spherical aberration, coma, pincushion and barrel distortions, keystoning, etc. Many of the aberrations occur as the image is transferred through the various optical components of the system. While these display devices may have a better weight distribution than the previously described front mounted image generator display devices, there is still substantial weight distributed over the user's eye due to the presence of these optical elements.

It would be desirable to prepare a head mountable display device that minimizes the weight distribution of the image generator and optical elements, especially in the front portion of the device. This would reduce the fatigue associated with such devices, allowing a user to use the device for longer periods of time.

### SUMMARY OF THE INVENTION

A head mountable apparatus is described for transmitting an image to the user's eye using switchable holographic optical elements. In one embodiment, an optical system is provided that is configured to receive an image provided by an image generator and which forms a light path along which light is transmitted from the image generator to an eye of the user. The optical system includes a first switchable holographic optical element configured to operate in an active state or an inactive state, wherein the first switchable holographic optical element is configured to diffract the image light incident thereon when the first switchable holographic optical element operates in the active state, and wherein the first switchable holographic optical element transmits the image light incident thereon without substantial alteration when the first switchable holographic optical element operates in the inactive state.

### BRIEF DESCRIPTION OF THE DRAWINGS

Other objects and advantages of the invention will become apparent upon reading the following detailed description and upon reference to the accompanying drawings in which:

FIG. 3 is a general arrangement drawing illustrating a viewing apparatus and method;

FIG. 4 is a schematic view of a first embodiment of a viewing apparatus;

FIG. 4A is a detail of part of the apparatus shown in FIG. 4;

FIGS. 4B to 7 are graphs illustrating various characteristics of the apparatus of FIG. 4;

FIG. 8 is a schematic view of a modification to the first embodiment of the viewing apparatus;

FIG. 8A is a detail of part of the apparatus shown in FIG. 8;

FIG. 9 is a schematic view of a second embodiment of a viewing apparatus;

FIG. 10 is a schematic view of a modification to the second embodiment of the viewing apparatus;

FIG. 11 illustrates a third embodiment of a viewing apparatus that uses an electrically switchable holographic composite (ESHC);

FIGS. 11A and 11B illustrate the operation of the ESHC;

FIGS. 12 and 13 illustrate the use of an alternative form of image generator in the apparatus;

FIGS. 14 and 15 show arrangements enabling the viewing of the surroundings in addition to a displayed image;

FIGS. 16 to 18 are schematic views of further embodiments of a viewing apparatus showing in particular an eye tracker;

FIG. 19 is a diagram illustrating the general principle of a dynamic optical device as embodied in the viewing apparatus;

FIG. 20 is a diagram illustrating the use of a dynamic hologram;

FIGS. 21 and 21A illustrate the use of planar display screens and dynamic optical devices;

FIG. 22 is an exploded perspective view of an apparatus for viewing an image, employing an ESHC as the dynamic optical device;

FIG. 23 is a schematic section through the apparatus shown in FIG. 22;

FIG. 24 is a schematic sectional view of an arrangement wherein the apparatus is of generally curved configuration;

FIG. 25 is a schematic sectional view of another embodiment of the apparatus;

FIG. 26 is a schematic sectional view of part of an image generator;

FIGS. 27A, 27B and 27C are schematic views of different optical arrangements for the apparatus;

FIG. 28 is a schematic view of apparatus for use by multiple observers;

FIGS. 29 and 30 are schematic plan views of apparatuses for use in displaying stereoscopic images;

FIGS. 31 to 35 show a further embodiment of a viewing apparatus;

FIGS. 36, 36A and 36B show a modification of the embodiment depicted in FIGS. 31 to 35;

FIG. 37 is a perspective schematic diagram of a further specific embodiment of apparatus in accordance with the invention;

FIG. 38 is a plan view of the apparatus illustrated in FIG. 37;

FIG. 39 is a plan view of yet a further specific embodiment of apparatus in accordance with the invention;

FIG. 40 is a view of the dynamic optical device of the apparatus illustrated in FIG. 39, in use, in the direction indicated by arrows X in FIG. 39;

FIG. 41 is a cross-sectional view of an apparatus for viewing an image;

FIG. 42 is a schematic side view of an embodiment of an image generator;

FIG. 43 is a perspective view of the switchable holographic optical elements of the apparatus;

FIG. 44 is a perspective view of the housing of the apparatus;

FIG. 45 is schematic view of the optical elements of an embodiment of the apparatus in which the ray traces through the optical elements are shown;

FIG. 46 is a schematic view of an embodiment of an apparatus for viewing an image which includes a transmissive and a reflective optical elements;

FIG. 47 depicts a schematic view of an embodiment of an apparatus for viewing an image which includes two reflective optical elements;

FIG. 48 depicts a schematic view of an embodiment of an apparatus for viewing tiled images.

While the invention is susceptible to various modifications and alternative forms, specific embodiments thereof arc shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

In head-mounted optical displays (such as are used in the recreation industry for viewing virtual reality images), it has been the practice to project an image to be viewed into the observer's eyes using conventional refractive and reflective optical elements, i. e. lenses and mirrors. However, in head mounted displays where weight and size are major considerations it is normally possible to provide only a very small field of view by this means, which is a disadvantage when it is desired to provide the observer with the sensation of being totally immersed in a virtual world. In an attempt to overcome this problem, it has been proposed to use so-called “pancake windows”, i. e. multi-layer devices which use polarisation and reflection techniques to simulate the effect of lenses and mirrors. However, such devices suffer from the problem that they have low transmissivity.

It is known that diffraction techniques can be used to simulate the effect of a lens. For example, referring to FIGS. 1 and 2 of the accompanying drawings, the profile of a conventional refractive lens can be reduced to a kinoform by cutting the lens into slices each of which is of a thickness that induces a phase shift of 2n in the light transmitted there through, and then eliminating those regions of constant thickness. Each slice corresponds to a zone in the lens having a maximum depth (corresponding to first order diffraction) of λ/n−1, where n is the refractive index of the lens material and λ is the wavelength of the light. The profile of the kinoform can then be approximated by discrete multi-level step profiles, to form a binary lens. In the illustrated example, 8 such levels are used. A substrate of suitable material can then be formed with diffractive structures which correspond to the step profile of the binary lens, for example by photolithography, diamond turning or laser machining.

Recent research suggests that this technique can also be applied to spatial light modulators, such as liquid crystals. In this case, it would be possible to vary the characteristics of the modulator virtually at will, to create different diffractive structures in different parts of the modulator and to alter these in real time, forming a dynamic optical device, such as a lens.

A method of viewing an image is taught which comprises transmitting an image into an eye of an observer by means of a dynamic optical device (as defined herein), controlling the characteristics of the dynamic optical device to create an area of relatively high resolution in the direction of gaze of the observer's eye, the dynamic optical device providing a lesser degree of resolution of the image elsewhere, and sensing the direction of gaze of the observer's eye and altering the characteristics of the dynamic optical device in accordance therewith, so that the area of relatively high resolution is made to follow said direction of gaze as the latter is altered.

The expression “transmitting an image” is intended to include the formation of a virtual aerial image at some point, or the projection of a real image onto the surface of the observer's retina.

An apparatus is also taught for viewing an image, the apparatus having a dynamic optical device (as defined herein) by means of which the observer's eye views an image in use, sensing means operative to sense the direction of gaze of the observer's eye, and control means which acts on the dynamic optical device to create an area of relatively high resolution in said direction of gaze, the dynamic optical device providing a lesser degree of resolution of the image elsewhere, the control means being responsive to the sensing means and being operative to alter the characteristics of the dynamic optical device to move said area of relatively high resolution to follow said direction of gaze as the latter is altered.

The term “dynamic optical device” means an optical device which operates to create a phase and/or amplitude modulation in light transmitted or reflected thereby, the modulation capable of varying from one point or spatial region in the optical device to another, and wherein the modulation at any point or spatial region can be varied by the application of a stimulus. In this way, the optical power (focal length), size, position and/or shape of the exit pupil and other optical parameters can be controlled.

The above-described method and apparatus allow the provision not only of a relatively wide field of view, but also a large exit pupil, a movable exit pupil of variable shape, and high resolution. The apparatus can also be arranged to provide for the full range of accommodation and convergence required to simulate human vision, because the parameters governing the factors can be altered dynamically.

Preferably, the sensing means utilises radiation which is scattered from the observer's eye and which is detected by detector means, and the dynamic optical device also functions to project said radiation onto the eye and/or to project to the detector means the radiation reflected by the eye.

Conveniently, the dynamic optical device comprises a spatial light modulator containing an array of switchable elements in which the optical state of each element can be altered to create a change in phase and/or amplitude in the light incident thereon. Alternatively, the dynamic optical device can comprise an array of switchable pre-recorded holographic elements, wherein more complex phase functions can be encoded within the holograms. In this case, the dynamic optical device can also comprise non-switchable holographic elements.

Advantageously, the dynamic optical device comprises an electrically switchable holographic composite.

Desirably, the dynamic optical device is used in a range in which the phase and/or amplitude modulation varies substantially linearly with applied stimulus.

The dynamic optical device is preferably used in a range in which it does not substantially affect the amplitude and/or wavelength characteristics of the light transmitted or reflected thereby.

The dynamic optical device can be in the form of a screen adapted for mounting close to the observer's eye. The screen can be of generally curved section in at least one plane. Conveniently, the apparatus also comprises means for engaging the screen with the observer's head in a position such that the curve thereof is generally centred on the eye point. In one arrangement, the dynamic optical device acts upon light transmitted therethrough, and the image generator is located on a side of the dynamic optical device remote from the intended position of the observer's eye. In an alternative arrangement, the dynamic optical device acts upon light reflected thereby, and the image generator is at least partially light-transmitting and is located between the dynamic optical device and the intended position of the observer's eye.

In one arrangement, the control means acts on the dynamic optical device to create at least in said area of relatively high resolution a plurality of discrete optical elements in close juxtaposition to each other, each of which acts as an individual lens or mirror. Conveniently, some of the discrete optical elements act to direct to the observer's eye light of one colour, while others of the discrete optical elements act to direct to the observer's eye light of other colours. In an alternative arrangement, the control means is operative to alter periodically the characteristics of the dynamic optical device so that, at least in said area of relatively high resolution, the dynamic optical device acts sequentially in time to direct light of different colours to the observer's eye. Thus, the dynamic optical device changes its “shape” to diffract each primary wavelength in sequence.

As a further alternative, the dynamic optical device can comprise a succession of layers which are configured to act upon the primary wavelengths, respectively.

Advantageously, the dynamic optical device functions to correct aberrations and/or distortions in the image produced by the image generator. The dynamic optical device can also function to create a desired position, size and/or shape for the exit pupil.

Conveniently, the sensing means includes a plurality of sensors adapted to sense the attitude of the observer's eye, the sensors being positioned in or on the dynamic optical device and/or the image generator.

Preferably, the sensing means comprises emitter means operative to emit radiation for projection onto the observer's eye and detector means operative to detect radiation reflected back from the eye.

Desirably, the sensing means utilises infra-red radiation. In this case, the dynamic optical device can be reconfigured to handle visible light on the one hand and infra-red radiation on the other.

The apparatus can further comprise at least one optical element, provided in tandem with the dynamic optical device, which acts upon infra-red light but not upon visible light. The detector means can be provided on a light-transmitting screen disposed between the image generator and the dynamic optical device. Conveniently, a reflector is disposed between the image generator and the light-transmitting screen, and is operative to reflect the infra-red radiation whilst allowing transmission of visible light, such that the infra-red radiation after reflection by the observer's eye passes through the dynamic optical device and the light-transmitting screen, and is reflected by said reflector back towards the screen.

In cases where the sensing means operates on infra-red principles, it is necessary to focus onto the detectors the returned infra-red radiation after reflection from the observer's eye. Although it is possible to employ for this purpose the same optical elements as are used to focus the image light onto the observer's eye, the disparity in wavelength between visible light and infra-red radiation means that this cannot always be achieved effectively. According to a development of the invention, the sensing function is performed not by infra-red radiation but rather by means of visible light. The light can be rendered undetectable by the observer by using it in short bursts. Alternatively, where the emitter means is provided at pixel level in the field of view, the wavelength of the light can be matched to the colour of the surrounding elements in the image. As a further alternative, the light can be in a specific narrow band of wavelengths. This technique also has applicability to viewing apparatus other than that including dynamic optical devices, and has a general application to any apparatus where eye tracking is required.

Preferably, the emitter means and/or the detector means are provided on a light-transmitting screen disposed between the image generator and the dynamic optical device.

Desirably, the image generator is in the form of a display screen, and the emitter means and/or the detector means are provided in or on the display screen.

Conveniently, the emitter means are provided in or on the display screen, a beamsplitter device is disposed between the display screen and the dynamic optical device and is operative to deflect radiation reflected by the observer's eye laterally of the main optical path through the apparatus, and the detector means are displaced laterally from the main optical path. Where the image generator produces a pixellated image, the emitter means and/or detector means can be provided at pixel level within the field of view. Advantageously, the image generator and the dynamic optical device are incorporated into a thin monolithic structure, which can also include a micro-optical device operative to perform initial beam shaping. The monolithic structure can also include an optical shutter switchable between generally light-transmitting and generally light-obstructing states. The apparatus can further comprise means to permit the viewing of ambient light from the surroundings, either separately from or in conjunction with the image produced by the image generator. In this case, the image generator can include discrete light-emitting elements (such as lasers or LEDs) which are located on a generally light transmitting screen through which the ambient light can be viewed.

Preferably, the light-emitting elements of said device are located at the periphery of said screen, and the screen acts as a light guide member and includes reflective elements to deflect the light from the light-emitting elements towards the dynamic optical element. Desirably, the image generator is in the form of a display panel, and the panel is mounted so as to be movable between a first position in which it confronts the dynamic optical device and a second position in which it is disposed away from the dynamic optical device. In an alternative arrangement, the image generator is in the form of a display screen and displays an input image, and the apparatus further comprises detector means operative to sense the ambient light, a processor responsive to signals received from the detector means to display on the display screen an image of the surroundings, and means enabling the display screen to display selectively and/or in combination the input image and the image of the surroundings. In one particular arrangement, the image generator comprises an array of light-emitting elements each of which is supplied with signals representing a respective portion of the image to be viewed, the signals supplied to each light-emitting element are time-modulated with information relating to the details in the respective portion of the image, and the area of relatively high resolution is produced by means of the dynamic optical device switching the direction of the light from the light-emitting elements in the region of the direction of gaze of the observer's eye. The apparatus can further comprise tracking means operative to track the head positions of a plurality of observers, and a plurality of sensing means each of which is operative to detect the direction of eye gaze of a respective one of the observers, with the dynamic optical device being operative to create a plurality of exit pupils for viewing of the image by the observers, respectively.

The image produced by the image generator can be pre-distorted to lessen the burden on the dynamic optical device. In this case, the distinction between the image display and the dynamic optical device is less well defined, and the functions of the image generator and the dynamic optical device can be combined into a single device, such as a dynamic hologram. More particularly, a spatial light modulator can be used to produce a dynamic diffraction pattern which is illuminated by one or more reference beams.

Preferably, said image for viewing by the observer is displayed on a display screen, which can be of generally curved section in at least one plane. The apparatus can further comprise means for engaging the display screen with the observer's head in a position such that the curve thereof is generally centred on the eye point.

The apparatus can form part of a head-mounted device.

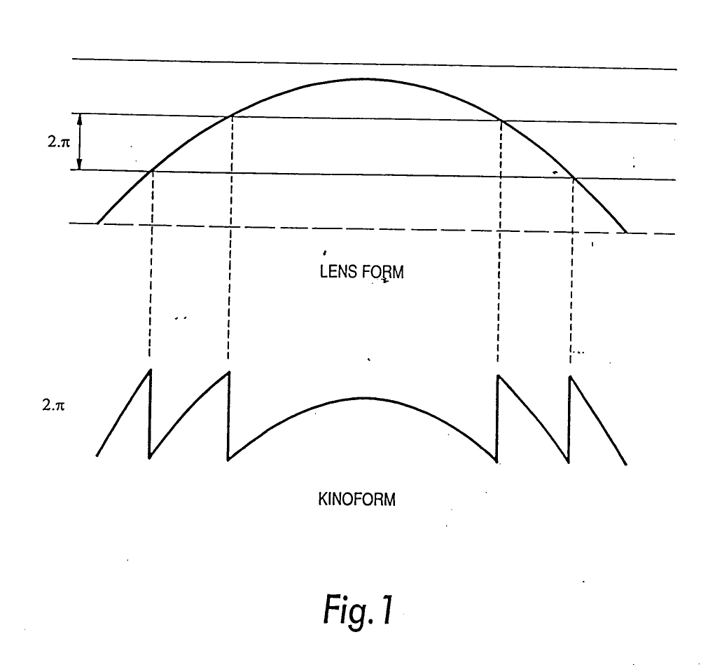

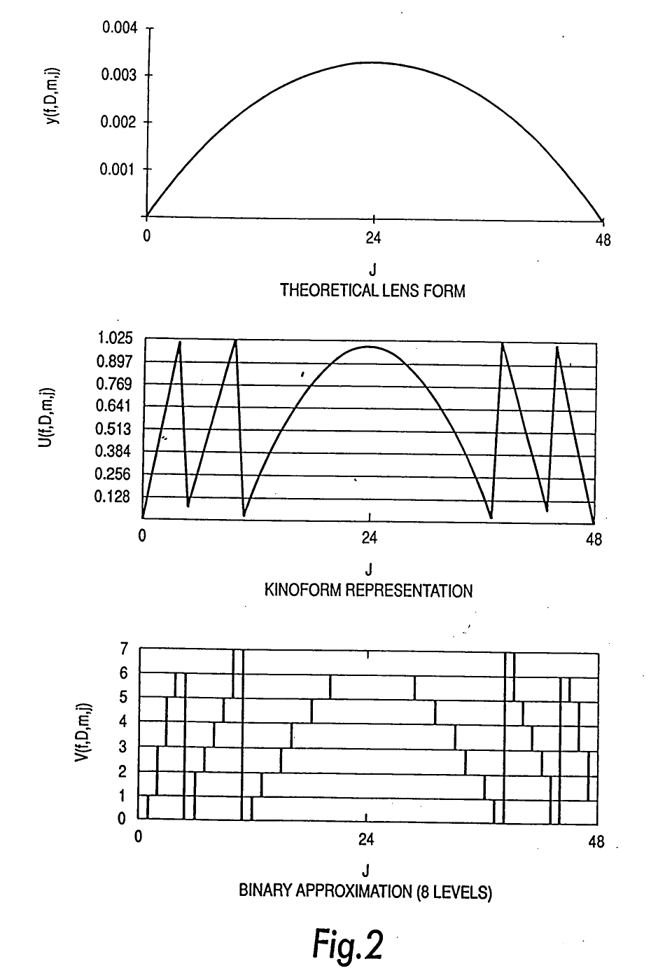

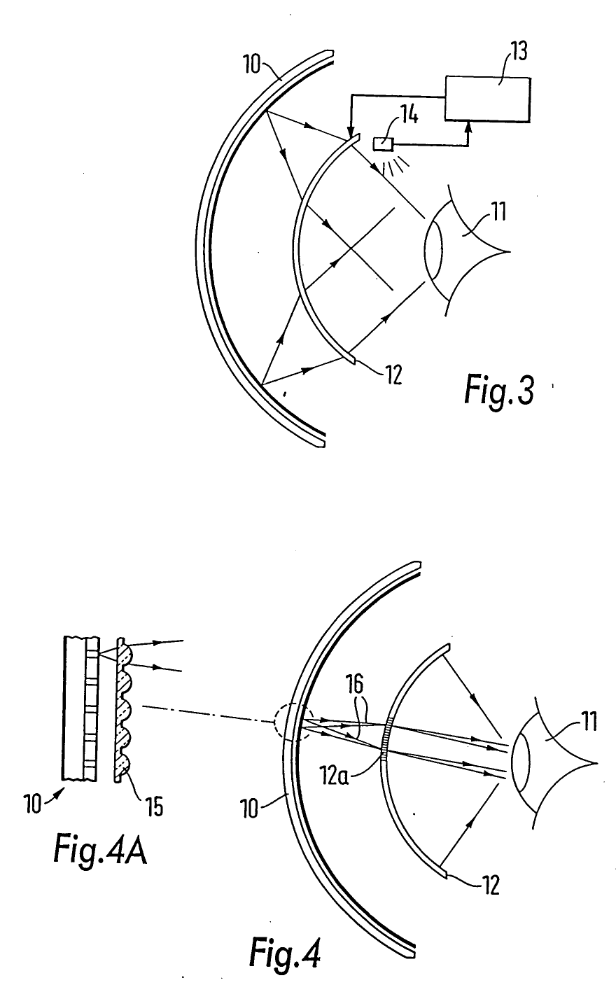

Referring to FIG. 3, there is shown a general arrangement of viewing apparatus which comprises a display screen 10 on which is displayed an image to be viewed by an eye 11 of an observer. Interposed between the display screen 10 and the eye 11 is a dynamic optical element (in this case, a lens) in the form of a screen 12. The dynamic lens comprises a spatial light modulator (such as a liquid crystal device) to which a stimulus is applied by a control device 13 to create an area of relatively high resolution in the direction of gaze of the eye 11, the remaining area of the modulator providing a lesser degree of resolution. Sensing means 14 is operative to sense the attitude of the eye li, and the control device 13 is responsive to signals received from the sensing means 14 and alters the characteristics of the modulator so that the area of relatively high resolution is moved so as to follow the direction of gaze of the observer's eye 11 as this is altered.

The apparatus and its characteristics will now be described in more detail. Although the described apparatus is intended for use in a head-mounted device for viewing virtual reality images it will be appreciated that the apparatus has many other uses and applications as well.

In the ensuing description, reference will be made to the apparatus as being applied to one of the observer's eyes. However, when used for virtual reality applications, two such apparatuses will in fact be provided, one for each eye. in this case, the respective display screens can (if desired) be used to display stereoscopic images to provide a 3-D effect to the observer.

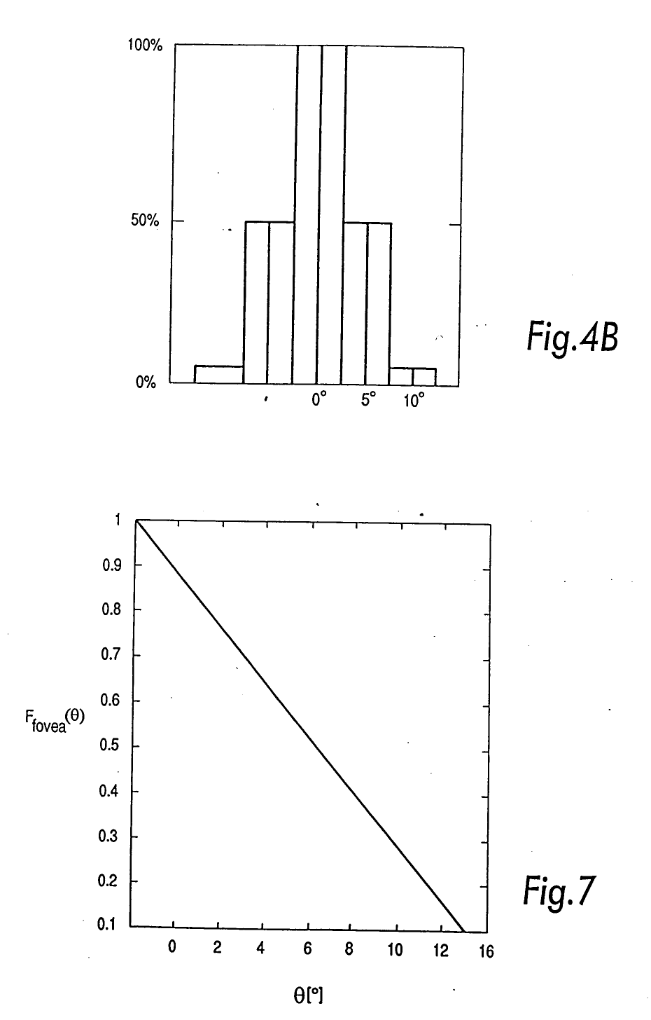

FIGS. 4 and 4A show a first actual embodiment of the viewing apparatus, wherein similar components are designated by the same reference numerals as used in FIG. 3. However, the control device 13 and the sensing means 14 are omitted for the sake of clarity. In this embodiment, the display screen 10 and the screen 12 are each of curved configuration and are centred generally on the rotation axis of the observer's eye 11.

The spatial light modulator comprising the screen 12 can operate on phase and/or amplitude modulation principles. However, phase modulation is preferred because amplitude modulation devices tend to have relatively low light efficiency. The modulator has a phase modulation depth of not less than 2π and its phase shift varies linearly with applied voltage.

The aperture and focal length of the dynamic lens formed by the spatial light modulator, are dictated by the resolution of the modulator. The form of the lens is modified in real time, allowing the focal length to be changed so that conflicts between accommodation and convergence can be resolved. In addition, focus correction for different users can be carried out electronically rather than mechanically.

The dynamic lens is intended to provide an area of interest (AOI) field of view, the AOI being a high resolution region of the field of view that corresponds to the instantaneous direction of gaze of the observer's eye. By reducing the size of the AOI, certain benefits arise such as minimising the amount of imagery that needs to be computed for display on the screen 10 at any instant, improving the image quality by allowing the dynamic lens to operate at low field angles, and increasing the effective image brightness and resolution of the display. FIG. 4B shows in graphic form the variation of resolution across the AOI.

Normally, the optics required to achieve human visual fields of view involve very complex optical designs consisting of many separate lens elements. The concept employed in the present invention achieves economy of design by using an adaptive lens in which its transform is re-computed for each resolution cell of the field of view. Furthermore, since the dynamic lens is used with a device (eye tracker) which senses the attitude of the observer's eye, only a modest AOI is required. Accordingly, the form of the lens is simplified, although separate lens forms are required for each increment in the field of view to ensure that collimation is preserved over the entire field of view.

The diffractive principles employed by the spatial light modulator are ideally suited to correcting for monochromatic aspheric and high order spherical aberrations, distortion, tilt and decentering effects. However, since diffractive structures suffer from chromatic aberration, it is necessary to compute separate forms for each wavelength, and in particular to recompute the diffraction pattern for each of the primary wavelengths used in the display. For example, in one arrangement the dynamic optical device is configured to produce an array of discrete micro-lenses in close juxtaposition to each other, with some of the micro-lenses acting to direct to the observer's eye red light, whilst other micro-lenses act to direct green and blue light to the observer's eye, respectively. In a second arrangement, the characteristics of the dynamic optical device are altered periodically so that, at least in the area of high resolution, it acts to direct to the observer's eye red, green and blue light in temporal sequence. In a third arrangement, the dynamic optical device comprises several layers which are designed to act on red, green and blue wavelengths, respectively.

The resolution of the apparatus is dependent upon several factors, especially the dimensions of the dynamic lens, the resolution of the spatial light modulator, the number of phase levels in the spatial light modulator, focal length and pixel size of the display screen 10. In order to achieve a satisfactory resolution, the dynamic lens is operated not as a single lens, but rather as an array of micro-lenses as depicted schematically at 12a in FIG. 4.

Diffracting structures are subject to similar geometric aberrations and distortions to those found in conventional lenses. By using an eye tracker in conjunction with an area of high resolution in the dynamic lens, the effects of distortion are minimal, particularly since low relative apertures are used. Generally, diffractive optics are more difficult to correct at high optical powers. From basic aberration theory, the field angle achievable with the dynamic lens is limited to a few degrees before off-axis aberrations such as coma start to become significant and it becomes necessary to re-compute the diffraction pattern.

In general, the correction of geometric distortions and matching of the AOI with lower resolution background imagery can be carried out electronically. Particularly in the case where the dynamic lens is implemented in a curved configuration (as depicted in FIG. 4), the effects of geometric distortion will be minimal.

The main factors affecting transmission through the dynamic lens are the diffraction efficiency, effective light collection aperture of the optics, and transmission characteristics of the medium employed for the dynamic lens. Because of the geometry of the dynamic lens, the effect of occlusions and vignetting will be minimal. The most significant factor tends to be the collection aperture. In order to maximise the transmission of the display to the dynamic lens, it is possible to include an array of condensing lenses. FIG. 4A shows a detail of the display screen 10 depicted in FIG. 4, wherein an array 15 of micro-lenses is disposed in front of the display screen 10 to perform initial beam-shaping on the light emitted from the screen, before this is transmitted to the dynamic lens. Alternatively, this beam-shaping function can be performed by means of diffractive or holographic components.

Because the operation of the dynamic lens is governed by the attitude of the observer's eye, the majority of the processing of the image displayed on the screen 10 at any one time will be concerned with the image region contained in the exit pupil. To take full advantage of the eye's visual acuity characteristics, the eye tracker is arranged to operate at bandwidths of at least 1000 Hz in order to determine the tracking mode of the eye (for example smooth pursuit or saccade).

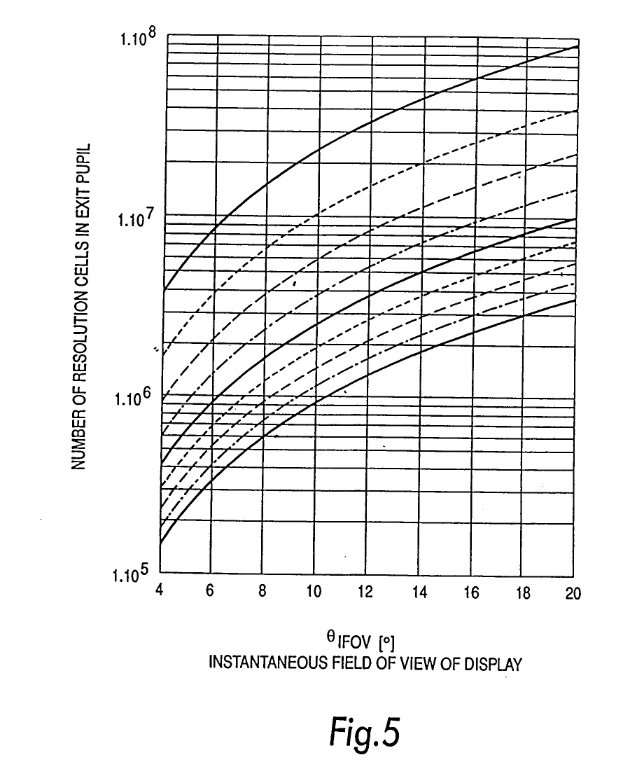

The picture content in the exit pupil of the dynamic lens at any given time will depend upon the AOI field, of view, and the field angle and resolution of the dynamic lens. FIG. 5 shows in graphic form a calculation of the number of resolution cells in the exit pupil that will need to be up-dated per frame as a function of the AOI for different values of the dynamic lens field angle. For the purpose of these calculations, it has been assumed (for illustrative purposes) that the dynamic lens consists of 20×20 micro-lenses each of 0.5 mm, size, with each micro-lens having a resolution of 48×48. It has also been assumed that the dynamic lens has a field of view of 7′, and that the AOI is 10″. This results in a total of about one million cells in the exit pupil, equivalent to a 1000×1000 array. Taking into account the dynamic lens field angle, each of these cells will need to be up-dated approximately 2 times per frame, i. e. 2 million cell up-dates per frame are required. By extrapolating from the size of the exit pupil to the maximum array size necessary to provide the same resolution over an entire field of view of, say, 1350×180′, it can be determined that a dynamic lens comprising of the order of 113×113 micro-lenses will be required (equivalent to a 5400×5400 cell spatial light modulator).

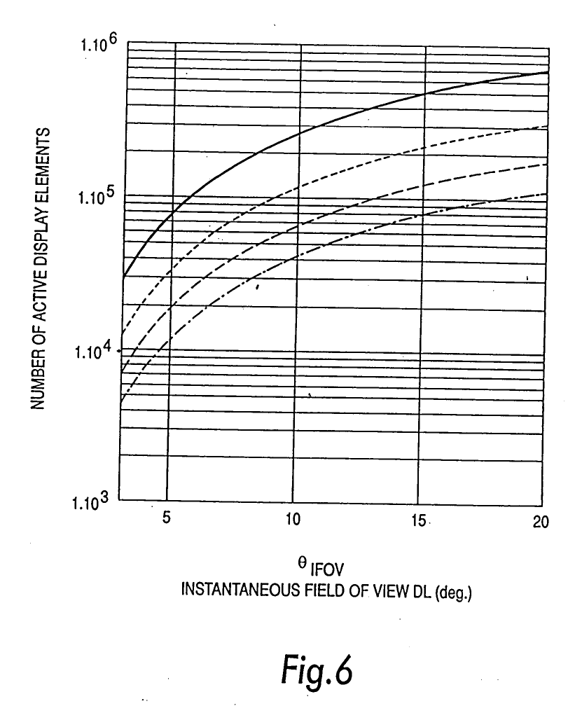

The specification of the input image display (i. e. the image as displayed on the screen 10) will be determined by the required display resolution. For example, by aiming to match the 1 minute of arc resolution of the human visual system, the display will need to provide a matrix of 8100×8100 pixels to achieve the desired performance over a field of view of 1350×1800. The number to be up-dated in any given frame will be considerably smaller. FIG. 6 shows in graphic form the number of active display elements required in the exit pupils, assuming a variable resolution profile of the form shown in FIG. 7.

Significant economy in the computation of the input imagery can be achieved by exploiting the rapid fall-off of human visual acuity with angle. Since only 130,000 pixels can be observed by the eye at any time, and noting that the eye is not very good at distinguishing intermittent events at moderate rates (typically 30 per second), it can be concluded that the apparatus of the present invention presents a processing requirement which is not significantly bigger than that of a 625 line television.

The exit pupil of the dynamic lens is not subject to the same physical constraints as that of a conventional lens system, since it is defined electronically. According to the normal definition of the term, it could be said that the exit pupil covers the whole of the 135′×180′ field of view. However, because of the eye tracking function employed in the present invention, it is more appropriate to consider the exit pupil as being the region of the spatial light modulator array contained within the eye-tracked area of interest. The remainder of the field of view is filled with imagery whose resolution progressively decreases as the periphery is approached.

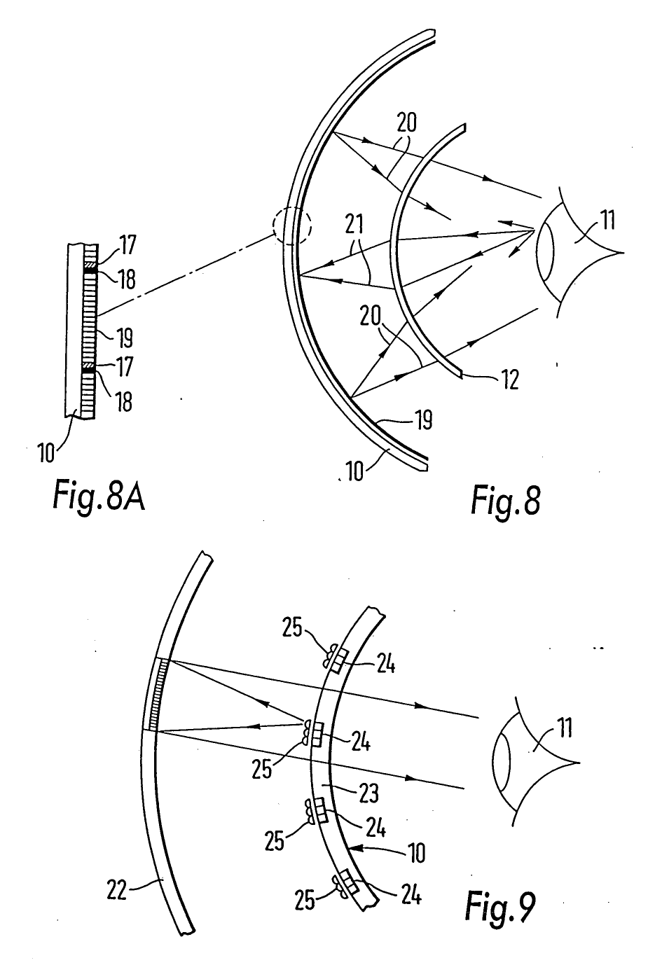

FIG. 8 illustrates a particular manner of implementing the eye tracking function, with similar components being accorded the same reference numerals as employed in FIG. 4. In this embodiment, the eye tracking function is achieved by means of an array of emitters 17 and detectors 18 provided on a screen 19 disposed immediately in front of the display screen 10. Radiation (such as infra-red radiation) is emitted by the emitters 17 and is directed by the dynamic lens 12 as a broad wash across the observer's eye 11, as depicted by arrows 20. The radiation reflected by the eye 11 is then focused by the dynamic lens 12 onto the detectors 18, as depicted by arrows 21. Thus, the dynamic lens 12 not only functions to transmit to the observer's eye the image as displayed on the screen 10, but also forms an important part of the eye-tracker. The spatial frequencies of the emitters 17 and detectors 18 do not have to be very high, but are sufficient to resolve the eye of the pupil or some other ocular parameter.

FIG. 9 shows an alternative embodiment in which the dynamic optical element takes the form of a mirror 22 rather than a lens. In this arrangement, the display screen 10 is interposed between the dynamic mirror 22 and the observer's eye, and is formed by a generally light-transmitting screen 23 on which are provided a series of visible light emitters 24 (such as LEDs, lasers or phosphors) in red-green-blue triads. The triads are spaced apart from one another, to permit the eye 11 to view the displayed image after reflection by the dynamic mirror 22 and subsequent passage through the screen 23. Each triad is fronted by a micro-lens array 25 which performs initial beam shaping.

The dynamic mirror 22 is based on the same diffractive optical principles as the dynamic lens. The use of reflection techniques can offer some advantages over a transmissive mode of operation because the drive circuitry for the spatial light modulator can be implemented in a more efficient way, for example on a silicon backplane. As in the case of the dynamic lens, the limited resolution of currently available spatial light modulators will dictate that the mirror 22 is made up of an array of miniature dynamic mirrors, each comprising a separate diffracting array. By arranging for the display screen 10 to have a suitably high pixel resolution, the displayed area of interest image can be built up by generating a different field of view element for each pixel, in a similar way to a dynamic lens. Alternatively, the image can be generated by modulating the emitters 24 and synchronously modifying the diffracting patterns contained in the mirror 22 in such a way that the required image is produced by switching the direction of the emitted light in the field of view. This has the advantage of requiring fewer elements in the partially transmitting panel 23 and hence allowing a higher transmission. An equivalent approach can also be used in the case where the dynamic optical element is a lens.

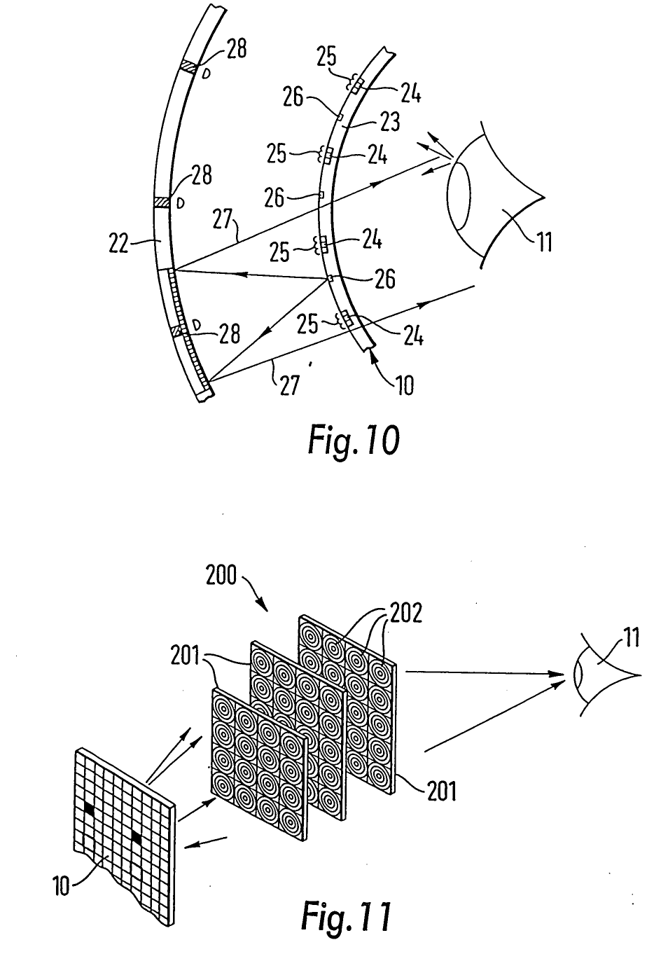

FIG. 10 illustrates the application of the eye tracker to apparatus of the type shown in FIG. 9. More particularly, emitters 26 of radiation (such as infra-red light) are provided on the light-transmitting screen 23 and emit radiation towards the dynamic mirror 22. The mirror 22 then reflects that radiation as a broad wash through the screen 23 and onto the observer's eye 11, as depicted by arrows 27. Radiation reflected by the eye 11 passes back through the screen 23 and onto detectors 28 provided on the mirror 22. Other configurations are, however, possible. For example, both the emitters 26 and detectors 28 could be mounted on the panel 23, with the dynamic mirror performing the functions of receiver and transmitter optics.

In the above-described embodiments, reference has been made to the spatial light modulator comprising a liquid crystal device. However, other types of spatial light modulator can also be used, such as surface acoustic wave devices and micro-mirror arrays.

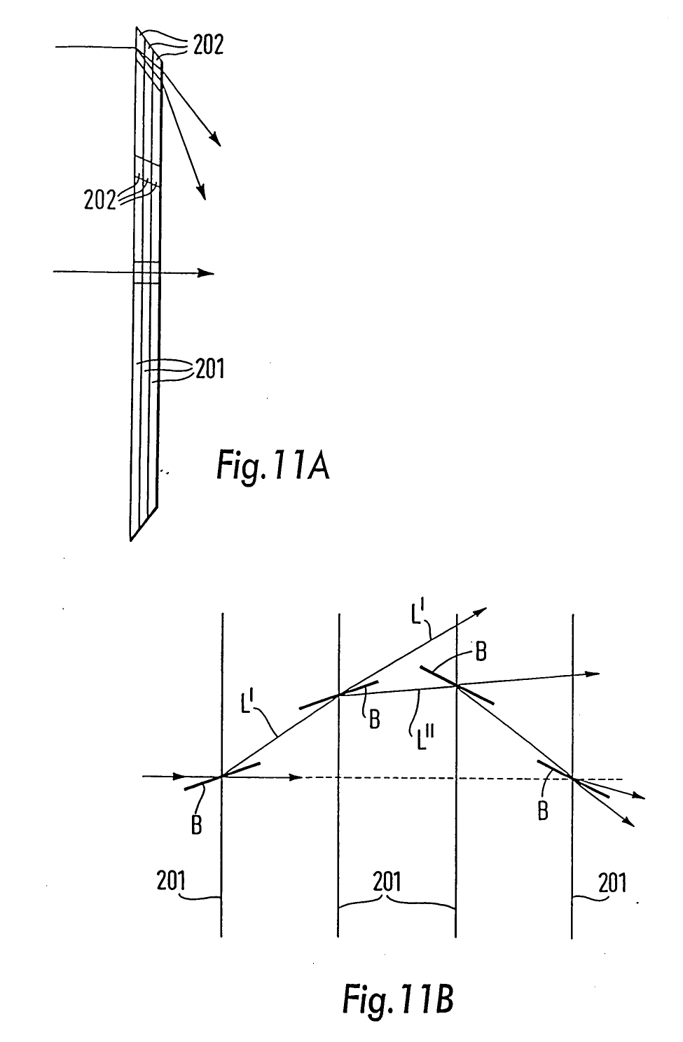

In a further embodiment (shown in FIG. 11) , the dynamic optical device 12 takes yet another form, namely that of an electrically switchable holographic composite (ESHC) . Such a composite (generally referenced 200) comprises a number of layers 201, each of which contains a plurality of pre-recorded holographic elements 202 which function as diffraction gratings (or as any other chosen type of optical element). The elements 202 can be selectively switched into and out of operation by means of respective electrodes (not shown)and sequences of these elements 202 can be used to create multiple diffraction effects. ESHCs have the advantages of high resolution, high diffraction efficiency, fast switching time and the capability of implementation in non-planar geometries.

If a liquid crystal display, surface acoustic element or micromirror device is used, the dynamic optical device will operate on the basis of discrete switchable elements or pixels. Although such a device can be programmed at pixel level, this is achieved at the expense of limited resolution. As a result, it is difficult to achieve very high diffraction efficiencies. In contrast, ESHCs have sub-micron resolution, which represents a substantially higher pixel density than that of the above described types of spatial light modulators. Typically, the resolution of conventional spatial light modulators are of the order of 512², representing about one million bits of encoded data: the diffraction efficiencies tend to be well below 50%. In contrast, ESHCs offer a resolution equivalent to 101′ bits, and diffraction efficiencies close to 100% are therefore a practical proposition.

An ESHC may be defined as a holographic or diffractive photopolymeric film that has been combined with a liquid crystal. The liquid crystal is preferably suffused into the pores of the film, but can alternatively be deposited as a layer on the film. The hologram may be recorded in the liquid crystal either prior to or after the combination with the photopolymeric film. Recordal of the hologram can be performed by optical means, or by the use of highly accurate laser writing devices or optical replication techniques. The resultant composite typically comprises an array of separate holograms that are addressed by means of an array of transparent electrodes manufactured for example from indium tin oxide, which usually have a transmission of greater than 80%.

The thickness of the composite is typically 10 microns or less. Application of electric fields normal to the plane of the composite causes the optical characteristics of the liquid crystals to be changed such that the diffraction efficiency is modulated. For example, in one implementation the liquid crystal is initially aligned perpendicularly to the fringe pattern and, as the electric field is increased, the alignment swings into the direction with the effective refractive index changing accordingly. The diffraction efficiency can be either switched or tuned continuously. Typically, the range of diffraction efficiencies covers the approximate range of 100% to 0.10-h. There is therefore a very large range of diffraction efficiency between the “fully on” and “fully off,” states of the ESHC, which makes the ESHC a very efficient switching device.

The speed of response is high due to the encapsulation of the liquid crystals in the micropore structure of the polymeric film. In fact, it is possible to achieve hologram switching times in the region of 1 to 10 microseconds using nematic liquid crystals. Ultimately, very high resolutions can be achieved, with equivalent array dimensions of up to 101 and sub-micron spot sizes. It is even possible to approach the theoretical ideal of a continuous kinoform.

Although the holographic diffraction patterns must be prerecorded and cannot be altered, a limited degree of programmability is possible. For example, it is possible to programme diffraction efficiency and relative phase in arrays of holographic elements arranged in stacks and/or adjacent to each other. A multi-layer ESHC of this type is essentially a programmable volume hologram. Taking multiple diffraction into account, a wavefront passing through the device could be switched into 2N Output wavefronts, where the integer N represents the product of the number of layers and the number of elements in each layer. As an illustration of the capability of such a device, in the case of a three-level system with each plane having a resolution of 8×8 elements, the number of possible output wavefronts is 2 197 (or 1017). Hence, the number of diffractive functions that can be implement-ed is practically unlimited. In practice, some of the layers in a stack would be provided with electrodes, whilst others would operate in a passive state.

Each wavefront can be made to correspond to a particular gaze direction. Manifestly, not all of the wavefronts would be generated at the same time because of the need for certain rays to use the same holograms along portions of their paths. However, by making the hologram array sizes suitably large and taking advantage of the characteristic short switching time, the requisite number of wavefronts can be generated at typical video rates of 50 Hz.

For example, to provide one minute of arc display resolution over an instantaneous eye track area of interest of size 100×100, a total of 600×600 separate wavefronts would need to be generated in 1/50 second, which is equivalent to 18×106 separate wavefronts in 20 milliseconds. Assuming that the input resolution of the portion of the hologram array stack that corresponds to the field of view is 30×30, and the entire holographic array can be switched in 1 microsecond, then the time required to generate the full set of wavefronts is equal to:

1×(18×106)/(30×30)=20 milliseconds.

To provide the same resolution and switching time over the maximum human monocular field of view of 1500×1350, a holographic array would be required with size equivalent to:

[(150/10)×301×[(135/10).×301=450×390.

By using a construction of the above-described type, it is also possible to arrange for all of the holographic elements in a layer to be switched simultaneously, with the selection of specific holograms in the layers being performed by appropriate switching of the individual light-emitting elements. Such “optical addressing” eliminates the wiring problems posed by having several high resolution hologram matrices. Furthermore, by recording multiple Bragg patterns in a given hologram, the number of possible deviation patterns for a light beam passing through that hologram can be increased, thereby enabling the number of layers in the ESHC to be reduced. The number of Bragg patterns that can be multiplexed depends on the refractive index modulation that is available, typically up to around 20 multiplexed patterns are possible. This reduces the effects of scatter and stray light, whilst stray light can be further minimised by the use of anti-reflection coatings applied to selected layers.

Because holograms are highly dispersive, the effects of chromatic aberration can be minimised by arranging for separate “channels” in the ESHC for the primary wavelengths, so that each channel can be optimised for the particular wavelength concerned. The term “channel” is intended to indicate a sequence of holographic elements through which the beam propagates. Also, chromatic aberration caused by the finite bandwidth of the light emitted by LEDs, can be reduced by employing suitable band pass filters.

An ESHC is typically a thick or volume hologram which is based on Bragg diffraction, giving a theoretical diffraction efficiency of 100 k. In principle, it is also possible to configure the ESHC as thin holograms (Raman-Nath regime), which can also give 100% efficiency in certain circumstances.

FIG. 11A depicts an ESHC in which the holographic elements 202 in successive layers 201 become progressively more staggered towards the periphery. This enables light rays (such as indicated at L) to be deviated at the periphery of the ESHC through larger angles than would otherwise be possible.

FIG. 11B is a schematic illustration of the way in which a light beam L′ can be deflected through differing angles by reflection at the Bragg surfaces B of the holographic elements in successive layers 201 of the ESHC. For example, L! denotes the path followed by a light beam which is deflected by a Bragg surface in the first of the layers 201 only, whilst L″ denotes the path followed by the same beam when the relevant holographic element in the next layer is activated so that the beam is deflected by a Bragg surface in that element also.

In a further development, the dynamic optical device can operate as a mirror, for example by combining an ESHC device with conventional silicon backplane technology, such as is used in active matrix liquid crystal displays.

As a further alternative, the dynamic optical device can take the form of a multi-layer liquid crystal divided into a number of individual cells, each of which is switchable between a limited number of states, which creates essentially the same effect as an ESHC.

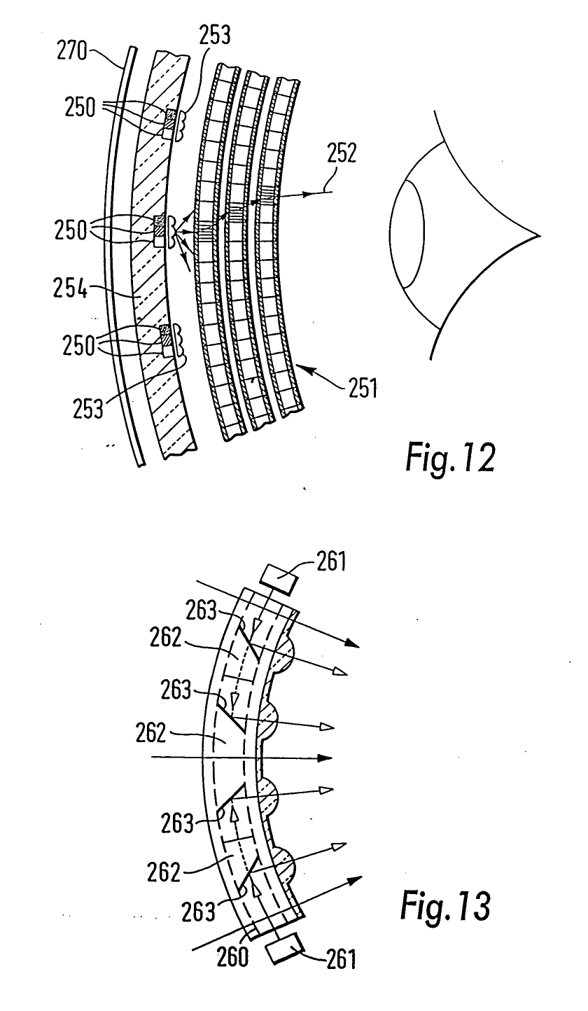

In the above-described embodiments, the image for viewing by the observer is generated by a display screen, in particular an LCD screen, although an electro luminescent screen or any other flatpanel screen (eg LED array) could be used instead. However, it is also possible to use other types of image generator. FIG. 12 shows one particular example, in which the input image data is generated by modulating an array of light emitting elements 250 (such as lasers or LEDs) at high frequency and using an ESHC 251 as described above to “switch” the laser beams between different orientations, such as indicated for laser beam 252. The lasers in the array can be configured as triads of red, blue and green. A micro-optic beam-forming system such as micro lenses 253 can be associated with the lasers.

FIG. 13 shows another example of the viewing apparatus, in which the image generator takes the form of a light guide panel 260 having a series of lasers 261 disposed around its periphery. Fabricated within the panel 260 are a series of-prisms 262 each of which has an inclined semi-reflecting surface 263 confronting one of the lasers 261. These surfaces 263 receive light from the lasers 261 and partially reflect this in a direction normal to the panel 260. Micro-lenses 264 are provided on a surface of the panel 260 which confronts the user, to focus and/or shape the respective laser beams.

As an alternative to lasers, LEDs of suitably narrow wavelength bands could be used. The lasers and/or LEDs can be fabricated from wide-band semiconductors such as GaN.

The image information is encoded by temporal modulation of the laser beams, and therefore the resolution of the laser array does not need to be large. This means that, by providing the laser array on a generally transparent panel, the observer can have the facility of viewing the surroundings. Furthermore, as shown in FIG. 12, it is possible to provide an external shutter 270 (such as by means of an additional layer of liquid crystal) whereby the observer can switch the surroundings into and out of view. In this manner, the observer can use the shutter to shut out external light whilst using the ESHC in diffractive mode to view a virtual display, or alternatively the shutter can be used to transmit light from the surroundings whilst switching the ESHC to non-diffractive mode. As a further alternative, the virtual imagery and ambient view can be superimposed in the manner of a head-up display. Under these circumstances, in order to avoid conflict with using the same processing elements in the ESHC for both virtual and ambient image scanning, the shutter liquid crystal can be provided as an array such that it is possible to switch off those pixels corresponding to field of view directions at which virtual imagery is to be displayed. Alternatively, other techniques can be employed, such as those based on polarisation, wavelength division, etc.

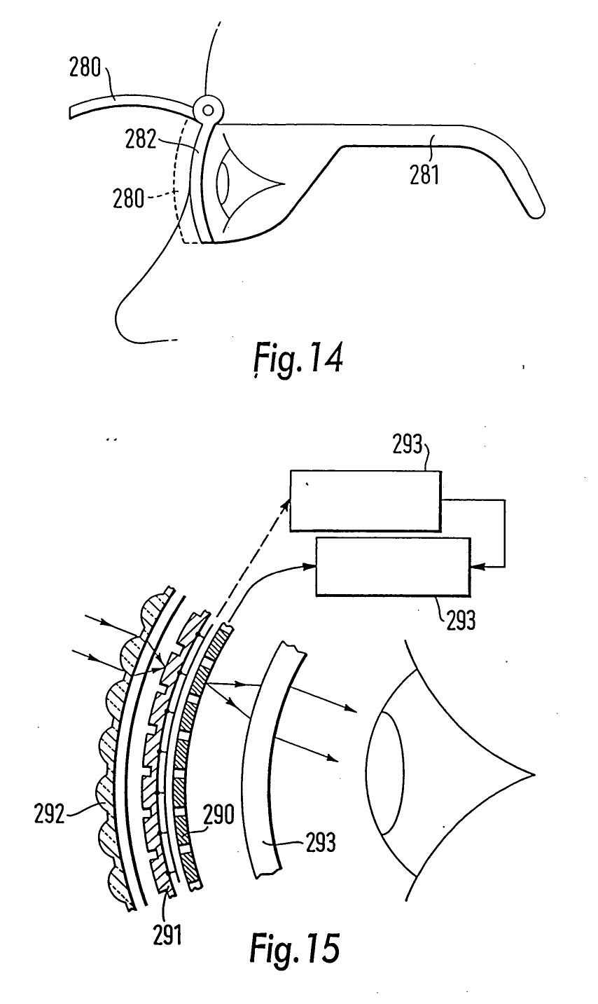

There are other ways in which a provision for viewing the surroundings can be included in the apparatus. For example, in the case where the image generator comprises an LCD or electro luminescent panel, gaps can be left in the display layer. Also, in the case where an LCD is used, a transparent back-lighting arrangement can be used. A further alternative is depicted in FIG. 14, wherein the display panel (referenced 280) is pivotally mounted on a headset 281 of which the apparatus forms part. The panel 280 can be pivoted between a first position (shown in broken lines) in which it confronts the dynamic lens (referenced 282), and a second position (shown in solid lines) in which it is disposed away from the lens 282 to allow ambient light to pass there through.

Another arrangement is shown in FIG. 15, wherein the display panel (referenced 290) does not allow ambient light to pass there through, and in which a detector array 291 is disposed on the external side of the panel 290 so that the detectors therein face the surroundings through a panel 292 of lenses. The lenses in the panel 292 form images of the surroundings on the detectors in the array 291, and signals received from the detectors are processed by a processor 293 for display on the display panel 290. In this way, the user can switch the display on the panel 292 between internal imagery and the surroundings, and view either of these by way of the dynamic lens (referenced 293).

In the above-described embodiments, the sensing means comprises emitters and detectors. The emitters emit radiation (such as infra-red radiation) which is projected as a broad wash onto the observer's eye, and the radiation scattered back from the eye is projected onto the detectors. On the one hand, the dynamic optical device functions not only to focus image light onto the observer's eye, but also to project the radiation from the emitters onto the eye and/or to project the radiation reflected by the eye to the detectors. On the other hand, the emitters and/or the detectors are provided at pixel level within the field of view of the observed image.

These general arrangements can be applied to viewing apparatuses other than those incorporating dynamic optical devices.

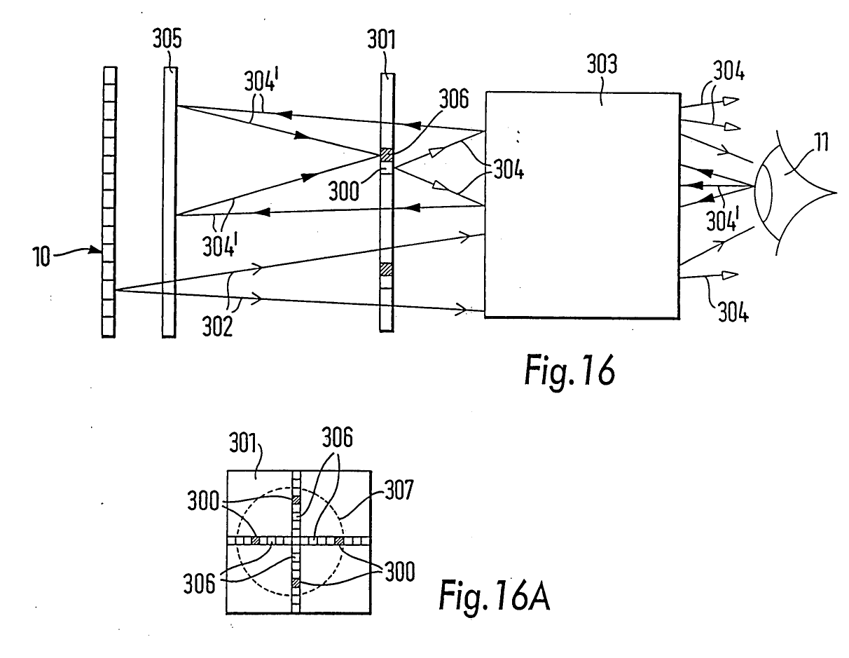

One such system is illustrated in FIGS. 16 and 16A, in which one or more infra-red emitters (referenced 300) are provided on a light-transmitting screen 301 positioned forwardly of the display screen 10. Image light 302 from the display screen 10 is directed to the observer's eye 11 by means of a lens system 303 (depicted schematically) which collimates the image light over a field of view of typically 40°. Infra-red radiation 304 from the emitter(s) 300 is projected as a broad wash onto the surface of the eye 11 by the lens system 303 and is scattered thereby. The returned infra-red radiation 304¹ is propagated back through the lens system 303, and is projected onto an element 305 positioned immediately in front of the display screen 10 which acts as a reflector to infra-red wavelengths but not to visible light. The element 305 can for example be a holographic or diffractive mirror, or a conventional dichroic mirror. After reflection by the element 305, the infra-red radiation is projected onto the screen 301 as a focused image of the pupil of the eye 11, and is incident upon one or more detectors 306 provided at pixel level in or on the screen 301. The arrangement of the emitters 300 and detectors 306 is such as to cause minimal obstruction to the passage of the image light through the screen 301.

FIG. 16A shows a cross-section of the screen 301, on which the focused pupil image is indicated by broken lines at 307. If (as shown) the detectors 306 are arranged in an array in the shape of a cross, then the dimensions of the instantaneous image 307 can be measured in two orthogonal directions, although other arrangements are also possible.

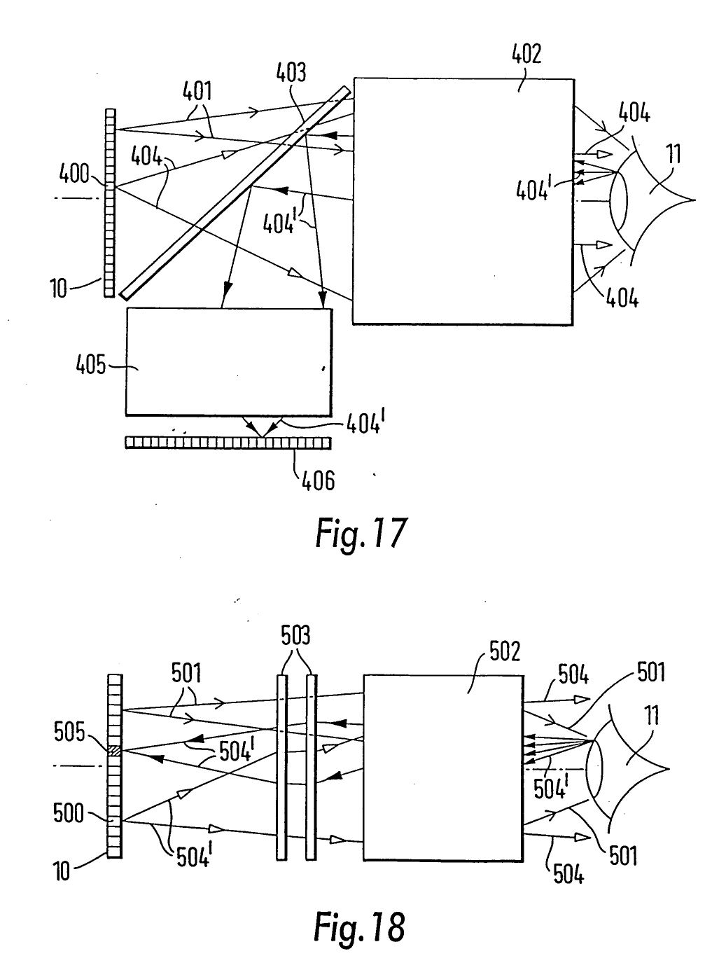

An alternative system is shown in FIG. 17, wherein a small number of infra-red emitters 400 (only one shown) are provided at pixel level in or on the display screen 10 itself. As in the embodiment of FIG. 16, image light 401 from the display screen 10 is directed to the observer's eye 11 by a lens system 402. In this embodiment, however, an inclined beamsplitter 403 is interposed between the display screen 10 and the lens system 402.

Infra-red radiation 404 from the emitters 400 passes through the beamsplitter 403 and is projected by the lens system 402 as a broad wash onto the observer's eye 11 to be scattered thereby. The returned infra-red radiation 404¹ passes through the lens system 402 and is then reflected by the beamsplitter 403 so that it is deflected laterally (either sideways or up or down) towards a relay lens system 405, which projects the returned infra-red radiation onto an array of detectors 406 to form a focused infra red image of the pupil on the detector array. Both the relay lens system 405 and the detector array 406 are thus displaced laterally from the main optical path through the viewing apparatus. In the illustrated embodiment, the beamsplitter 403 takes the form of a coated light-transmitting plate, but a prism can be used instead.

A further alternative arrangement is shown in FIG. 18, wherein one or more infra-red emitters 500 are again incorporated at pixel level in or on the display screen 10. As before, image light 501 from the display screen 10 is focused by a lens system 502 onto the observer's eye 11, with the lens system 502 collimating the visible light over a field of view of typically 40°. However, in this embodiment there is positioned between the display screen 10 and the lens system 502 one or more diffractive or holographic elements 503 which are optimised for infra- red wavelengths and which have minimal effect on the visible light from the display screen 10. Thus, the focal length of the combined optical system comprising the element (s) 503 and the lens system 502 for visible light is different from that for infra-red radiation. The combined effect of the element(s) 503 and the lens system 502 is to produce a broad wash of infra-red radiation across the surface of the observer's eye 11. Infra-red light scattered off the surface of the eye is then projected by the combined effect of the lens system 502 and the element (s) 503 onto the surface of the display screen 10 to form a focused infra-red image of the pupil, which is detected by detectors 505(only one shown) also provided at pixel level in or on the display screen 10.

In the embodiments of FIGS. 16 to 18, the lens systems 303, 402 and 502 are based on conventional refractive optical elements. However, the principles described can be applied to arrangements wherein a dynamic optical device is used instead.

Also in the embodiments of FIGS. 16 to 18, the lens systems 303, 402 and 502 perform the dual function of focusing the image light onto the observer's eye and of focusing the returned infrared radiation onto the detectors. The lens system must therefore cope with a wide variation of different wavelengths, and a lens system which has optimised performance with respect to visible light may not perform exactly the desired function with respect to infra-red radiation. In practice, the disparity is sufficiently small that it does not create a problem, particularly if near infra-red radiation is used. However, it is nevertheless sometimes desirable to incorporate some form of compensation for the infra-red radiation, such as the incorporation of the element(s) 503 in the embodiment of FIG. 18.

In an alternative arrangement, instead of employing infra-red radiation for eye tracking, it is possible to use light in the visible spectrum. This visible light could be rendered undetectable to the observer by using the light in very short bursts, or by allocating specific elements in the array for tracking (which could be colour-adjusted to match the surrounding image elements), or by using specific narrow bands of wavelengths.

The efficiency of the eye tracker will be limited by the latency of the processing system used to detect the variation in the ocular feature (such as the pupil edge, the dark pupil, etc) that is being used. In order to increase this efficiency, it is possible to use parallel processing techniques which can be implemented using hybrid electronic-optical technology, or even entirely optical processing methods. By harnessing the full speed advantage of optical computing, it is possible to perform eye tracking such that the image generator only needs to compute the data contained within the central 1° to 2° of the eye's field of view.

An optical computer for use with the present apparatus comprises components such as switches, data stores and communication links. The processing involves the interaction of the dynamic lens with the emitters and detectors. Many different optical processing architectures are possible, the most appropriate types being those based on adaptive networks in which the processing functions are replicated at each node. It is even possible to combine the image generator, optical computing structure and the dynamic lens into a single monolithic structure.

As explained above, a dynamic lens is a device based on diffraction principles whose optical form can be changed electronically. For example, this can take the form of a lens based on a binary profile, or a close approximation to the ideal kinoform, written onto a spatial light modulator or similar device. Although the primary use of the dynamic lens is to vary the focal length, it can also serve other functions such as to correct geometric distortions and aberrations. For example, chromatic aberrations can be reduced by re-calculating the diffraction pattern profiles (and hence the focal length) of the lens for each primary wavelength in sequence. Alternatively, three associated dynamic lenses could be used, each optimised for a different primary wavelength. These lenses can be augmented by bandpass filters operating at the primary wavelengths. In addition, the dynamic lens (in association with an input image array) can be used to vary the position, size and/or shape of the exit pupil in real time.

As a result of this, it is possible to achieve several advantageous effects. Firstly, a wide field of view (FOV) can be created, which helps realism. This stems primarily from the ability to move the exit pupil. The ability to implement imaging functions within a relatively thin architecture also helps to eliminate many of the geometrical optical obstacles to achieving high FOV displays. In contrast, in conventional optics a large exit pupil is achieved either by using mechanical means to move a small exit pupil (which is generally not practical given the problems of inertia, etc), or by using large numbers of optical elements to correct aberrations, etc, with consequent complexity and expense.

Secondly, the apparatus can be made light in weight so that it is comfortable and safe for a user to wear. This also means that the apparatus has low inertia, so the user has minimal difficulty in moving his or her head while wearing the apparatus. The reduction in weight results in part from the intrinsic lightness of the materials used to fabricate the spatial light modulator, as compared with those employed for conventional optics.

Thirdly, the functions of image transmission and eye tracking are combined into a single integral unit. This also assists in making the apparatus relatively low in weight. Furthermore, it also provides for easy area of interest detection and detail enrichment, which enables an effective high resolution to be achieved.

Fourthly, by suitably designing the software for driving operation of the dynamic lens, it is possible to prevent disassociation between accommodation and convergence, so that the apparatus does not place a visual strain on the user and provides a more realistic display. This is to be contrasted with conventional optics which, even if the relevant range information is available, are not capable of displaying objects at the correct depth without incorporating moving parts in the optical system or using other methods of changing the focal characteristics of the lenses.

A further advantageous property of the dynamic lens is its ability to reconfigure itself to allow different wavelength bands (e.g. visible and infra-red) to propagate through it. Multiple wavelengths can be transmitted simultaneously, either by allocating different portions of the dynamic lens to different wavelengths, or by reconfiguring the lens sequentially for those wavelengths. Moreover, the direction of propagation c′ those different wavelengths does not have to be the same. This makes the dynamic lens particularly useful in on the one hand transmitting image light for viewing by the observer, and on the other hand transmitting the infra-red light used in the eye tracker system.

Although the above description makes particular reference to dynamic lenses, it will be appreciated that the principles expounded are equally applicable to dynamic mirrors.

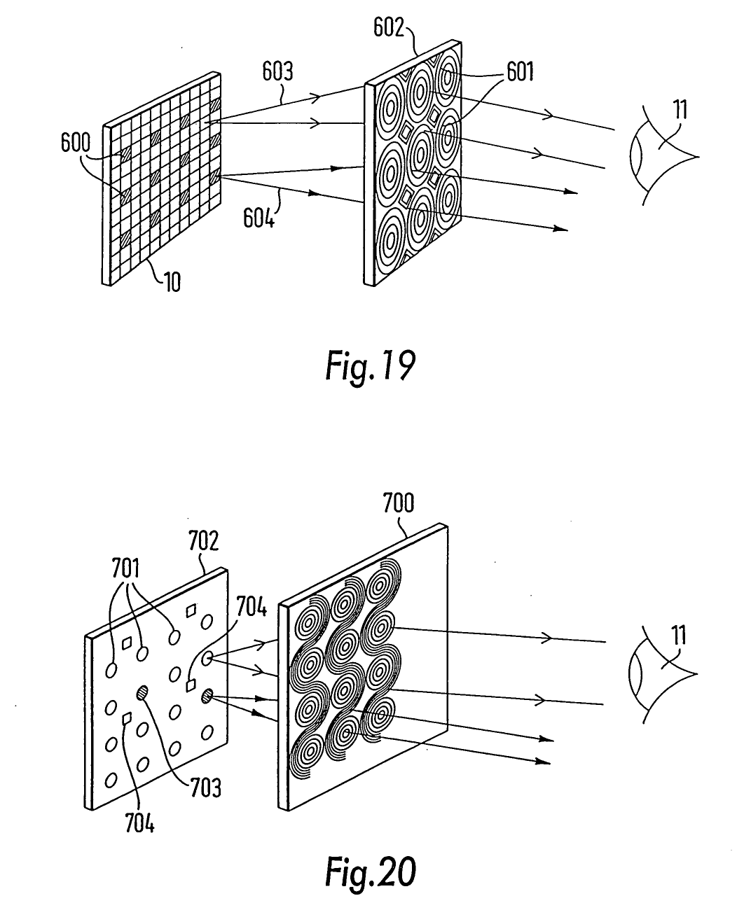

FIG. 19 illustrates the basic concept of a dynamic lens operating on diffraction principles. The display screen 10 embodies a number of infra-red emitters 600 at pixel level, and a series of diffraction patterns 601 are generated in a spatial light modulator 602 which serve the function of lenses, to focus image light 603 from the display screen 10 onto the observer's eye and to project the infrared light 604 from the emitters 600 as a broad wash onto the surface of the eye 11.

In order to reduce the burden on the dynamic lens and facilitate the diffraction calculations that are required in order to reconfigure the spatial light modulator each time the display is updated, it is possible to transform or distort the image as actually displayed on the display screen 10. Under these circumstances, the distinction between the input image display and the dynamic optical device becomes less well defined.

FIG. 20 illustrates a further development of the invention, in which the functions of image generation and dynamic imaging are combined within a dynamic holographic element 700. The required output image is then produced by reconstruction using only a series of reference beans produced by an array of discrete light sources 701. In the illustrated arrangement, the light sources 701 are mounted on a screen 702 disposed behind the dynamic holographic element 700, on which are also provided infra-red emitters 703 and detectors 704 for the eye tracking function.

The screen 702 thus performs no imaging function, i. e. it has no pictorial content, its purpose being merely to provide a set of reference beams. The resolution of the array of reference beam sources 701 can in fact be quite low, although the economy of design that results is achieved at the expense of the additional computational power required to re-calculate the hologram for each image update, since both the lens function and the image need to be recomputed.

The dynamic holographic element 700 can be implemented using a high resolution spatial light modulator such as that based on liquid crystals, micro-mechanical mirror arrays or opto-acoustic devices. It is possible for the dynamic hologram to operate either in transmission or in reflection. As is the case where a separate dynamic optical device and image generator are used, the use of reflective techniques can offer certain advantages, such as in allowing circuitry to be implemented in a more efficient way, and in enhancing the brightness of the display.

It is also possible to incorporate into the dynamic hologram lenses which project infra-red light from the emitters 703 onto the observer's eye, these lenses being encoded within portions of the hologram.

In a further modification (not shown), a texturised screen is provided around the periphery of the image displayed on the display screen. For reasons that are not yet fully understood, it has been found that the use of such a texturised screen can induce an illusion of depth in the displayed image, and this effect can be used to enhance the reality of the image as perceived by the user. The screen can be provided as a separate component which surrounds or partially overlies the periphery of the display screen. Alternatively, a peripheral region of the display screen itself can be reserved to display an image replicating the texturised effect. Moreover, under these circumstances it is possible to alter the display in that peripheral region to vary the texturised effect in real time, to allow for changes in the image proper as displayed on the screen and adjust the 11 pseudo-depth” effect in accordance with those changes.

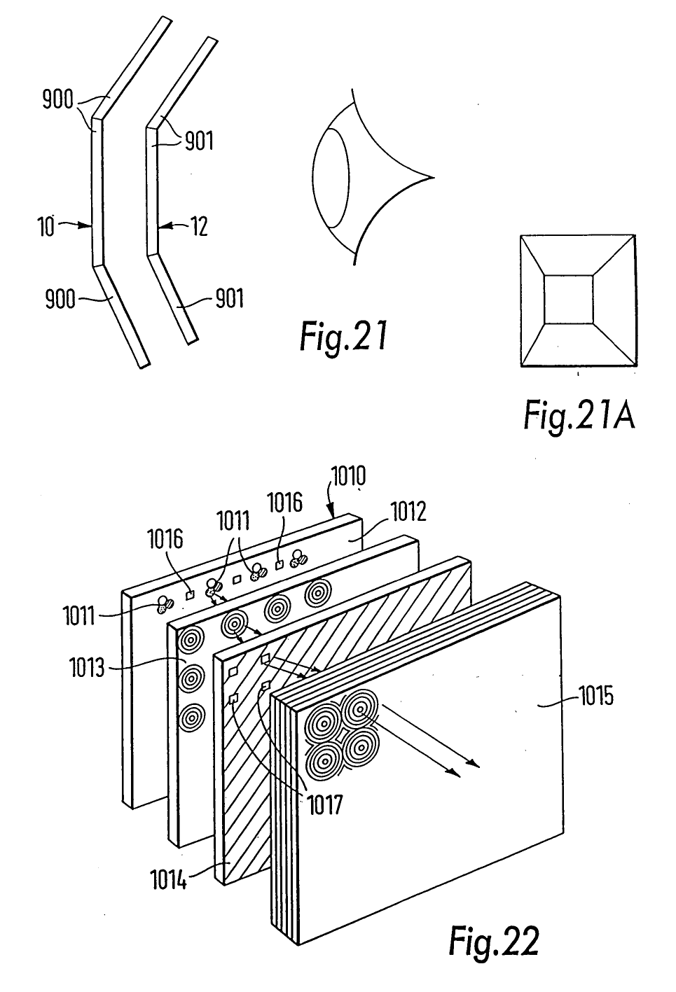

In the above embodiments, the display screen and dynamic lens are described as being curved. However, as depicted in FIGS. 21 and 21A, it is possible to construct the display screen 10 from a series of planar panels 900, and similarly to construct the dynamic lens 12 from a series of panels 901, each panel 900 and 901 being angled relative to its neighbour(s) so that the display screen and dynamic lens each approximate to a curve. FIG. 21 A shows the configuration of the screen 10 and lens 12 in three dimensions.

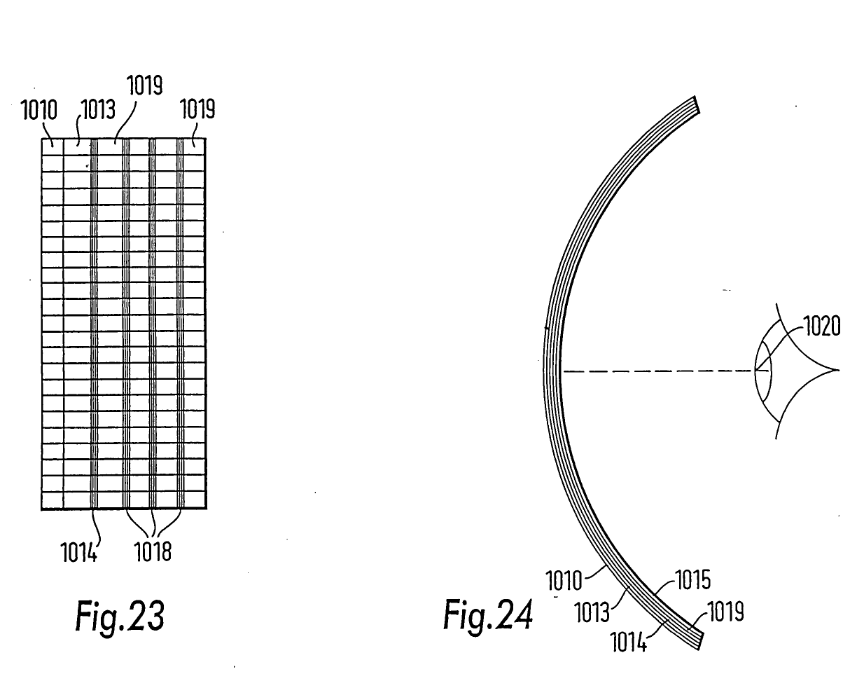

Referring now to FIGS. 22 and 23, there is shown apparatus for viewing an image which is generally similar to that depicted in FIG. 12. The apparatus comprises an image generator 1010 in the form of an array of LED triads 1011 provided on a generally light-transmitting screen 1012. The LED triads 1011 form a low resolution matrix of, say, 100×100 or 200×200 elements. Light from the LED triads 1011 is subjected to beam shaping by a micro-lens array 1013, and then passes through a liquid crystal shutter 1014 towards an ESHC 1015. The micro-lens array 1013 has as its main effect the collimation of the light emitted by the LED triads 1011, and can be of holographic design.

The LEDs in the triads 1011 are driven by signals defining an image to be viewed by an observer. On the one hand, these signals are such that the array of LEDs produces a relatively coarse version of the final image. on the other hand, the signals supplied to each LED triad are time-modulated with information referring to image detail, and the ESHC 1015 functions to scan the light from that triad in a manner which causes the image detail to be perceived by the observer.

The apparatus also comprises an eye tracker device which senses the direction of gaze of the observer's eye. Suitable forms of eye tracker are described above and are not shown in any detail herein. Suffice it to say that radiation from a plurality of emitters is projected onto the observer's eye in a broad wash, and radiation reflected back from the eye is projected onto detectors, such as detector elements 16 mounted in or on the screen 1012. The same optics as employed for image transmission are also used for the purpose of projecting the radiation onto the eye and/or projecting the reflected radiation onto the detector elements 1016.

As indicated above, the eye tracker senses the direction of gaze of the observer's eye. The operation of the ESHC 1015 is then controlled in accordance therewith, so that the ESHC functions to “expand” the resolution of the initially coarse image only in the direction in which the eye is looking. In all other areas of the image, the resolution is maintained at the initial coarse level. As the direction of gaze alters, the operation of the ESHC is changed as appropriate to “expand” the resolution in the new direction of gaze instead.

The liquid crystal shutter 1014 is switchable between two states, in the first of which the shutter is generally light-obstructing but contains windows 1017 for transmission of the light from the respective LED triads 1011. Within these windows, the liquid crystal material can control the phase of the light beams, for example to create fine-tuning of the collimation of those beams. In its second state, the shutter 1014 is generally light-transmitting and allows viewing of the ambient surroundings through the screen 1012, either separately from or in conjunction with viewing of the image from the LEDs.

The ESHC 1015 can include passive holograms (i. e. not electrically switched) that are written onto the substrates, to allow for greater flexibility in optimising the optical performance of the apparatus.

Instead of LEDs, the image generator 1010 can employ lasers.

As can be seen to advantage in FIG. 23, this form of construction enables a very compact monolithic arrangement to be achieved, comprising a succession of layers as follows:

the screen 1012 containing the LED/laser array

the micro-lens array 1013 embodied within a spacer

the liquid crystal shutter 1014

the ESHC 1015 comprising successive layers of holographic material 1018 plus electrodes, and spacers 1019 between these layers.

The first spacer 1019 in the ESHC (i. e. that directly adjacent to the liquid crystal shutter 1014) allows for development of the light beams from the LED triads after passing through the micro-lens array 1013 and before passing through the ESHC proper.

It is anticipated that the overall thickness of the apparatus can be made no greater than about 7.5 mm, enabling the apparatus to be incorporated into something akin to a pair of spectacles.

FIG. 24 shows a modified arrangement wherein the apparatus is of generally curved configuration, the curve being centred generally on a nominal eye point 1020. Typically, the radius curvature of the apparatus is about 25 mm.

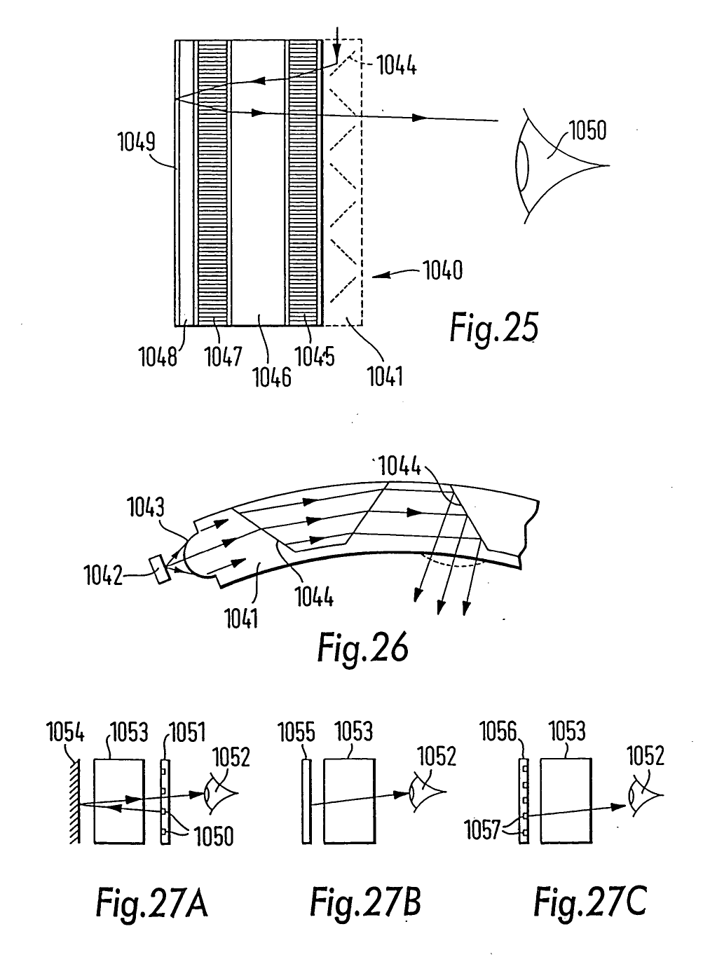

FIG. 25 shows an alternative arrangement, which operates on reflective principles. In this embodiment, the image generator 1040 comprises a light guide 1041 disposed on a side of the apparatus adjacent to the observer's eye. The light guide 1041 is depicted in detail (in curved configuration) in FIG. 26, and has a series of LEDs or lasers 1042 disposed around its periphery. Lens elements 1043 (only one shown) are formed on the periphery of the light guide 1041, and each serves to collimate the light from a respective one of the LEDs/lasers 1042 to form a beam which is projected along the guide 1041 through the body thereof. Disposed at intervals within the guide 1041 are prismatic surfaces 1044 (which can be coated with suitably reflective materials), which serve to deflect the light beams laterally out of the light guide 1041.

Disposed behind the light guide 1041 (as viewed by the observer) are, in order, a first ESHC 1045, a light-transmitting spacer 1046, a second ESHC 1047, a further light -transmitting spacer 1048, and a reflector 1049 (which is preferably partially reflecting). Light emerging from the light guide 1041 is acted on in succession by the ESHCs 1045 and 1047, is reflected by the reflector 1049, passes back through the ESHCs 1047 and 1045 and finally through the light guide 1041 to the observer's eye 1050. Because the light undertakes two passes through each of the ESHCs 1045 and 1047, this gives more opportunity for control of the beam propagation.

In practice, the apparatus shown in FIG. 25 can also include a micro-lens array and a liquid crystal shutter such as those described above with reference to FIGS. 22 and 23, but these have been omitted for convenience of illustration.

FIGS. 27A to 27C show in schematic form alternative configurations for the apparatus. In FIG. 27A, the image generator comprises an array of LEDs or lasers 1050 provided in or on a light transmitting screen 1051. As with the arrangement depicted in FIG. 25, the screen 1051 is disposed on a side of the apparatus adjacent to the observer's eye 1052. Light from the LEDs/lasers 1050 is initially projected away from the eye 1052 through an ESHC 1053, and is then reflected by a reflector 1054 back through the ESHC 1053. The light then passes through the screen 1051 and passes to the observer's eye. Again, this arrangement has the advantage that the light passes through the ESHC 1053 twice, giving increased opportunity for the control of the light beam shaping.

FIG. 27B shows in schematic terms an arrangement similar to that already described with reference to FIGS. 22 and 23, but wherein the image generator comprises a light guide 1055 of the general type shown in FIG. 26. FIG. 27C shows a similar arrangement, but wherein the light guide is replaced by a light transmitting screen 1056 having an array of LEDs or lasers 1057 therein or thereon.

As with FIG. 25, the micro-lens array and the liquid crystal shutter have been omitted from the drawings for ease of illustration, but will in practice be provided between the image generator and the ESHC in each case.

All of these arrangements are capable of being implemented as a monolithic, very thin panel (typically less than 10 mm in thickness) In practice, the overall thickness of the panel will be dictated by the required thickness of the substrates and spacers.

The use of a light guide such as described with reference to FIGS. 25, 26 and 27B can offer a greater degree of transparency to the image generator for viewing of the ambient surroundings.

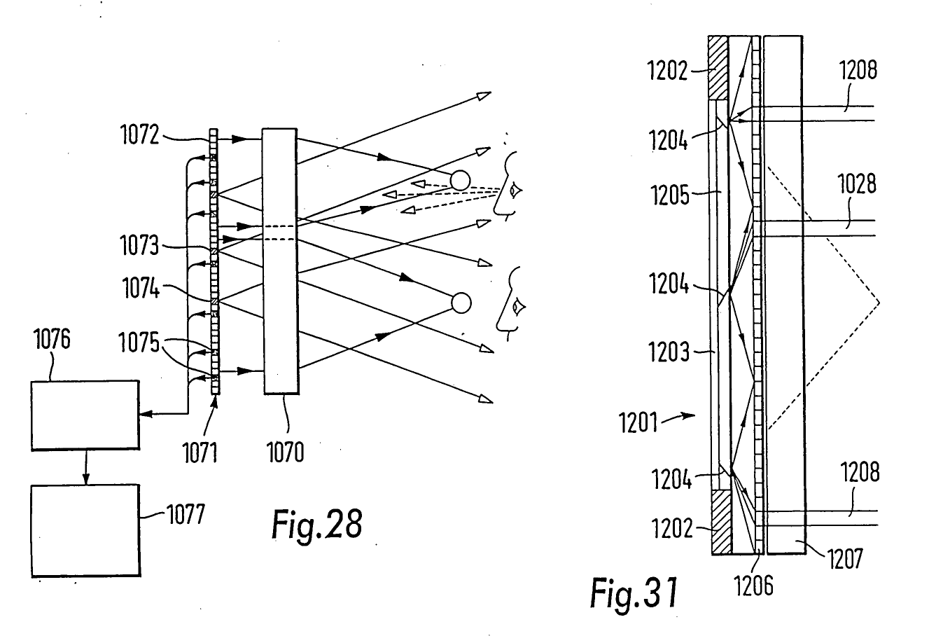

As depicted in FIG. 28, the apparatus can also be adapted for use by multiple observers, by arranging for the dynamic optical device (referenced 1070) to create more than one exit pupil, one for each of the intended observers. Reference numeral 1071 denotes an image generator comprising an array of LEDs/lasers1072 on a screen 1073, which screen also incorporates emitters 1074 and detectors 1075 of the eye tracking system. Signals received from the detectors 1075 are processed by a processor 1076 and a multiple-target tracking system 1077 which detects the positions of the heads of the various observers. The characteristics of the dynamic optical device 1070 are then altered in accordance with the detected head positions and directions of gaze, to create suitable exit pupils for viewing by the observers of the image transmitted by the image generator 1071.

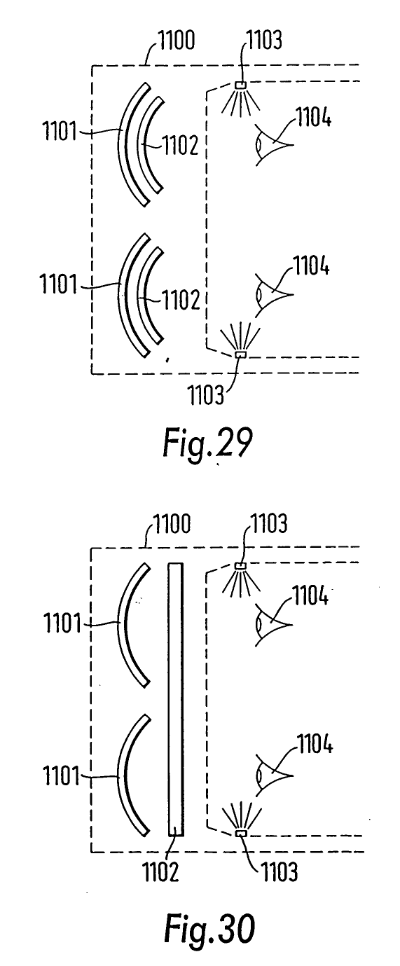

The apparatus can also be adapted for the viewing of stereoscopic images. For example, as shown in FIG. 29, a pair of apparatuses as described can be mounted side by side in a headset 1100. Each apparatus comprises generally an image generator 1101 (such as a display screen), a dynamic optical device 1102 and an eye tracker 1103. Stereoscopically paired images are produced by the image generators 1101, and are viewed by the observer's eyes 1104 respectively by means of the respective dynamic optical devices 1102. Each eye tracker 1103 senses the direction of gaze of the respective eye 1104, and the respective dynamic optical device 1102 maintains an area of high resolution in that direction of gaze, and alters this as the direction of gaze changes.

In an alternative arrangement (shown in FIG. 30), a single dynamic optical device 1102¹ is used in common to both apparatuses, and acts to create two areas of high resolution corresponding to the directions of gaze of the observer's eyes 1104, respectively. Under these circumstances, it may be possible to employ a single eye tracker 1103 which detects the direction of gaze of one eye 1104. One area of high resolution is created using signals obtained directly from the eye tracker, while the other area of high resolution is created in accordance with signals received from the eye tracker 1103 and information in the image input signal.

FIG. 31 shows a further embodiment of the invention in which the display screen (referenced 1201) is of a different form. In, for example, the embodiment of FIG. 12 the display screen comprises a monolithic LED array on a substrate. The size of this array is equivalent to a 768×768 matrix on a 60 mm substrate and, whilst this is not a particularly large matrix in purely numerical terms, the need to cluster the LEDs in a small area can pose difficulties due to the high density of wiring required. Also, the presence of this wiring on the substrate will have the effect of reducing the intensity of the light passing there through when the apparatus is used in a mode to view the surroundings.

The arrangement depicted in FIG. 31 is intended to solve this particular difficulty by employing photon generation modules 1202 which are disposed around the periphery of a transparent plate 1203. Each module 1202 is built up from a number of separate, lower resolution arrays of LEDs, as will be described later. The plate 1203 is moulded from plastics material and includes light guides 1204 and miniature lenses (not shown in FIG. 31) which are used to relay demagnified images of the LED arrays to each of a number of nodes 1205 situated directly in front of the micro-lens array (referenced 1206). Reference numeral 1207 designates the ESHC, while reference numerals 1208 indicate typical output light beams produced by the apparatus.

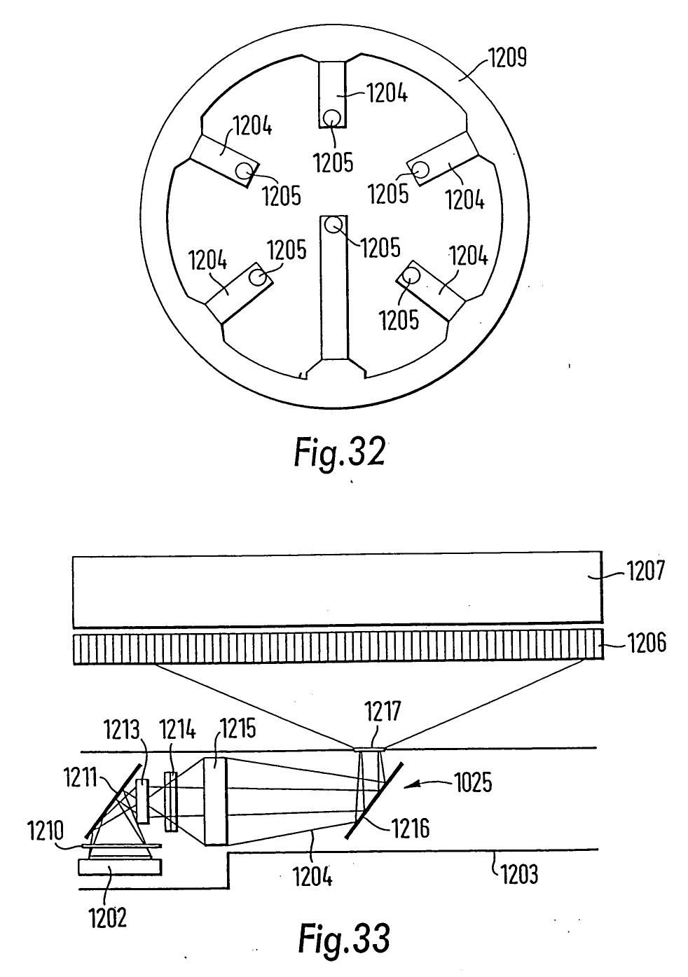

FIG. 32 shows a front view of the display screen 1201, wherein the positioning of light guides 1204 and nodes 1205 (six in all) can be seen to advantage. Reference numeral 1209 designates an opaque region in which the photon generation modules 1202 are located.

Mounting the photon generation modules 1202 around the periphery of the plate 1203 also solves the problem of decreasing geometric blur due to the finite size of the LED elements, since the ratio of pixel size to LED/micro-lens array distance must be kept small. Furthermore, the plate 1203 does not now have to be made of a suitable LED substrate material, and can simply be made of optical-grade plastics.

FIG. 33 shows the construction and operation of one LED array of a photon generation. module 1202 in detail. More particularly, the LED array is disposed parallel to the plate 1203, and light emitted therefrom is subjected to initial beam shaping by an optical element 1210 such as a holographic diffuser. The light is then reflected through 90′ inwardly of the plate 1203 by a reflector element 1211, and passes in sequence through a relay lens 1213, a focusing element 1214 (for example an LCD element) and a condenser lens 1215. The light then passes along the respective light guide 1204 to the respective node 1205, where it is deflected by a reflector element 1216 towards the micro-lens array 1206. on leaving the plate 1203, the light is spread by a beam diverging element 1217 provided on the surf ace of the plate 1203 confronting the micro-lens array 1206.

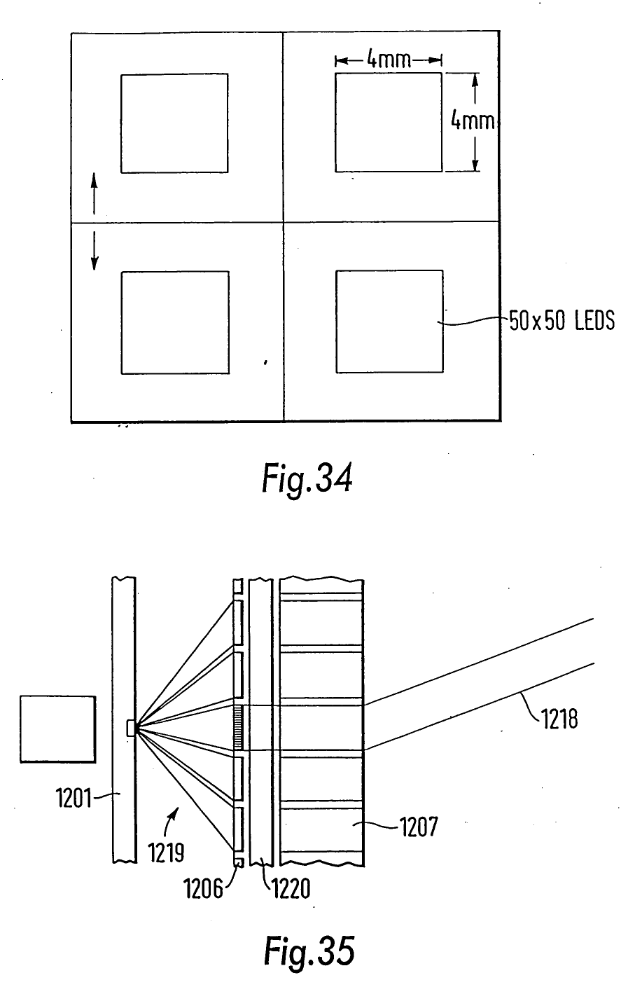

As indicated above, each of the photon generation modules 1202 is formed of a cluster of LED arrays. A typical example is shown in FIG. 34, wherein the module comprises four arrays 1221 each containing a 50×50 matrix of LEDs measuring 4 mm×4 mm. Because each of the arrays 1221 subtends a slightly different angle to the associated optics, the beams generated by the four arrays emerge at slightly different angles from the respective node 1205. This can be used to achieve a small amount of variation in the direction of the output beam for each channel of light passage through the assembly of the micro-lens array 1206 and the ESHC 1207.

FIG. 35 is a schematic view of apparatus embodying the above described design of display panel, illustrating the typical passage therethrough of an output beam 1218. The display panel 1201 is mounted on one side of a transparent light guide panel 1219, the panel 1219 having the array of micro-lenses 1206 mounted on its other side. An LCD shutter 1220 is disposed between the micro-lens array 1206 and the ESHC 1207. In this embodiment, the micro-lens array 1206 comprises a 36×36 array of independently switchable holographic micro-lenses, and the ESHC 1207 comprises a stack of substrates each containing a 36×36 array of simultaneously addressable holograms.

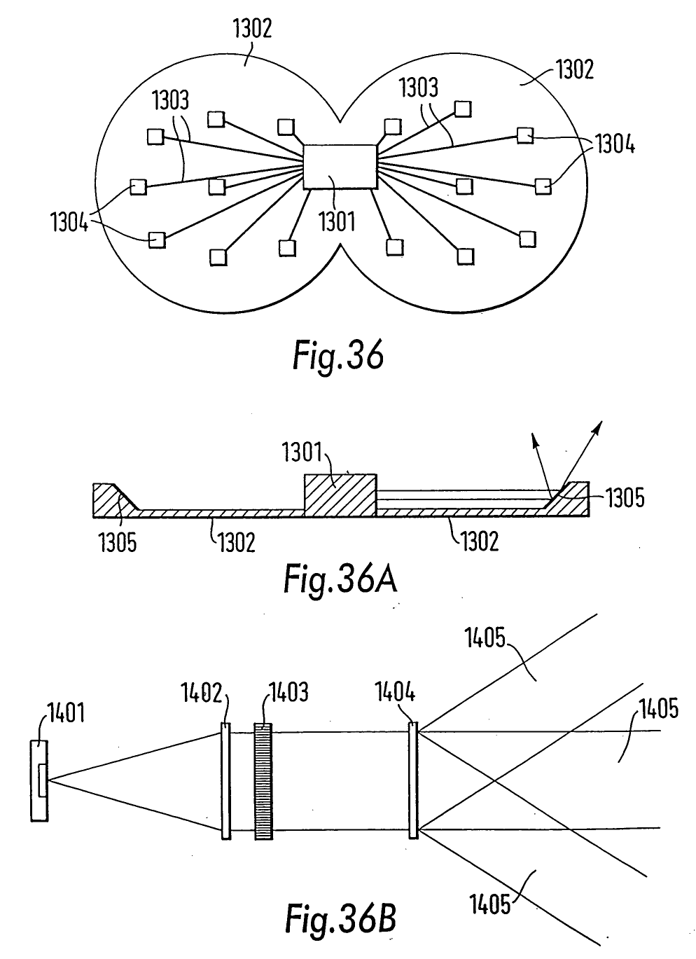

FIGS. 36 and 36A show an alternative arrangement wherein a single photon generation module (referenced 1301) is employed in common between display screens 1302 for viewing by the observer's two eyes, respectively. The module 1301 operates on essentially the same principles as that described in the embodiment of FIGS. 31 to 34, and is disposed intermediate the two display screens 1302. Each display screen 1302 includes light guides 1303 and nodes 1304 as before, the nodes 1304 in this instance being formed by curved mirrors 1305.

FIG. 36B shows schematically a manner in which the photon generation module can be implemented in this arrangement. More particularly, light from an LED array 1401 contained in the module is subjected to beam shaping by a lens 1402 and then passes through a liquid crystal array 1403. The beam then passes to a fixed grid 1404 which operates on diffraction principles to produce a plurality of output beams 1405 at defined angles, and the above-mentioned light guides are configured to match those angles.

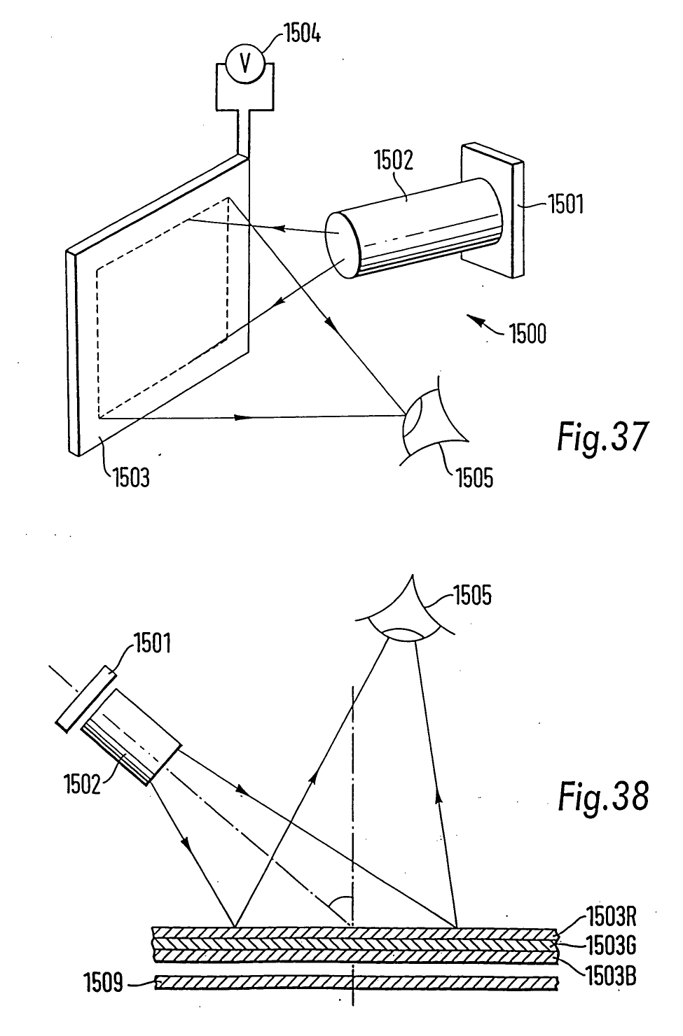

Referring now to FIGS. 37 and 38, a viewing apparatus 1500 includes an image generator 1501 arranged to emit light into projection optics 1502. The projection optics 1502 are arranged to project light from the image generator towards a dynamic optical element 1503, arranged at an acute angle with a principal axis of the projection optics 1502. The dynamic optical element 1503 is generally reflective, and is controlled by a controller 1504.

They dynamic optical element 1503 causes an image to be formed such that an observer 1505 viewing the image experiences a wide field of view. For clarity, tracking apparatus is not shown on the embodiment so illustrated, but it will be appreciated that eye tracking apparatus can be arranged therein.

The off-axis orientation of the arrangement is best illustrated in FIG. 38. As shown in that drawing, the dynamic optical element comprises Red, Green and Blue holographic layers 1503R, 1503G, 1503B. By enabling these layers sequentially, the element 1503 can present a full color image to a user.

When a layer is disabled, it is transparent. It will be understood from the above description that the arrangement is necessary because of the monochromatic nature of holographic elements. The high angle of incidence of light on to the dynamic optical element 1503 from the image generator 1501 and projection optics 1502 is clearly illustrated. It will be appreciated that the Red, Green and Blue channels of the element can be interspaced in one layer as an alternative.

Located behind the dynamic optical element 1503 is an ambient light shutter 1509. The ambient light shutter 1509 is operative, on receiving a stimulus from the controller 1504 to permit or to obstruct the passage of ambient light through the dynamic optical element. This gives the user the facility to mix the display from the image generator 1501 with the real-life view beyond the viewing apparatus 1500.

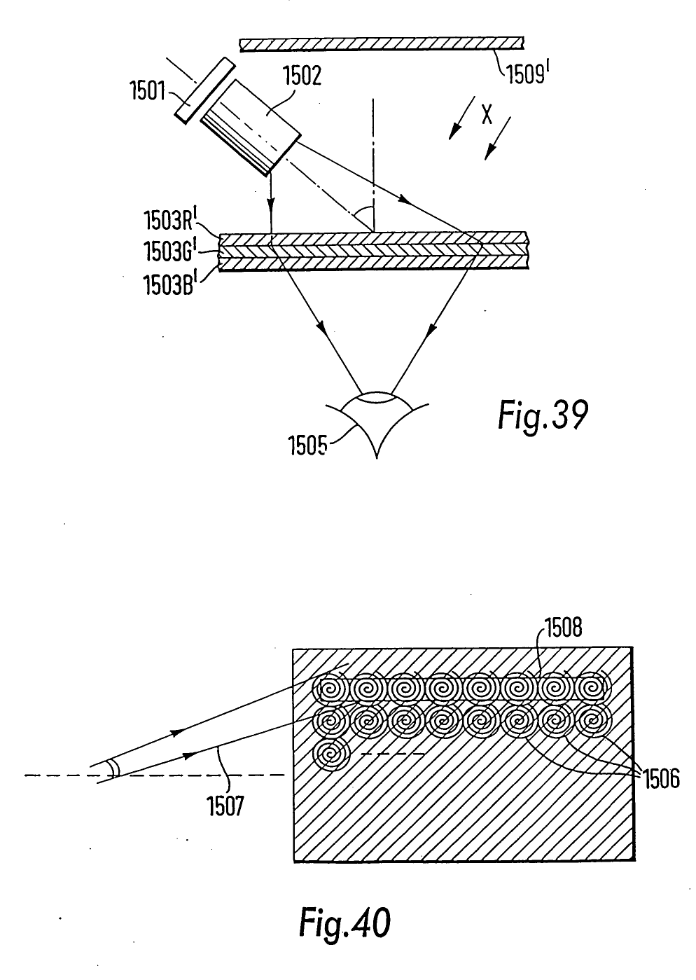

FIG. 39 illustrates an alternative arrangement which utilizes a transmissive dynamic optical element 1503′. All other components are assigned the same reference numbers as in FIGS. 37 and 38. Evidently, the observer 1505 now views the image from the opposite side of the dynamic optical element than the image generator 1501 and projection optics 1502.

FIG. 40 illustrates how the dynamic optical device 1503 can comprise a letterbox shutter layer. The letterbox shutter layer is omitted from FIGS. 38 and 39 for clarity. The dynamic optical device 2503 defines an array of microlenses 1506. The shutter layer is electronically controlled, such that for a given electronic signal a rectangular area or letterbox 1507 of the shutter layer becomes transparent, the remainder of the shutter layer remaining opaque. The letterbox 1507 is registered with a row of microlenses 1506. It may be registered with part of a row, or other combination of microlenses, if desired. In that way, by sequentially rendering specific areas 1507 of the shutter layer transparent, specific rows of the microlenses 1506 are exposed to light 1508 from the projection optics 1502. This reduces the possibility of accidental beam spillage over onto adjacent microlenses from those for which the beam is intended. In that way the quality of the viewed image is improved.

By virtue of the inherent angular selectivity of Bragg (volume) holograms, stray light which is predominantly parallel to the general plane of the shutter alignment, and which does not satisfy the Bragg condition will be undeflected. In this plane, the undeflected light will pass out of the field of view of the observer due to the off-axis arrangement, and thus the quality of the final viewed image can be improved.

The viewing apparatuses described above have many and varied applications, although they are designed primarily for use as head-mounted pieces of equipment. In a particular example, the equipment includes two such apparatuses, one for each eye of the user. In the entertainment field, the equipment can be used for example to display video images derived from commercially available television broadcasts or from video recordings. In this case, the equipment can also include means for projecting the associated soundtrack (e. g. in stereo) into the user's ears.

Also, by displaying stereoscopically paired images on the two apparatuses, the equipment can be used to view 3-D television. In addition, by arranging for the projected images substantially to fill the whole of the field of view of each eye, there can be provided a low-cost system for viewing wide field films.

In the communications sector, the apparatus can be used as an autocue for persons delivering speeches or reading scripts, and can be used to display simultaneous translations to listeners in other languages. The apparatus can also be used as a wireless pager for communicating to the user.

In another area, the apparatus can be used as a night-vision aid or as an interactive magnifying device such as binoculars. Also, the apparatus can be employed in an interactive manner to display a map of the area in which the user is located to facilitate navigation and route-finding.

Further examples demonstrating the wide applicability of the apparatus include its use in computing, in training, and in providing information to an engineer e.g. for interactive maintenance of machinery. In the medical sector, the apparatus can be used as electronic glasses and to provide disability aids. The apparatus can further be utilised to provide head-up displays, for example for use by aircraft pilots and by air traffic controllers.

The present invention may employ switchable holographic devices formed from materials described in U.S. Pat. No. 6,317,228 entitled Holographic Illumination System which is incorporated herein by reference.

FIG. 41 depicts a component of a head mountable apparatus for viewing an image. The component mat be attached to or a part of The component includes a housing 110 configured to be mounted on the head of a user (shown schematically as 111 in FIG. 41). The housing, in one embodiment, is composed of a generally straight portion 112 which extends along the user's head 111, and a curved front portion 113 which extends from a front end of the straight portion 112 across the adjacent eye 114 of the user. An image generator 115 may be disposed within the straight portion 112 adjacent its rear, and includes a display screen 116 on which an image is displayed. An optical system is disposed within the remainder of the housing 110 and acts to transmit light along a path from the image generator to the user's eye.

The optical system, in one embodiment, includes a first section 118, a portion of which is disposed in front of the user's eye 114, and a second section 117 which transmits light from the display screen 116 to the first section 118. The first section 118 is composed of at least one switchable holographic optical element. Examples of switchable holographic optical elements have been described in detail in the previous section. In general, switchable holographic optical elements include a holographic recording medium. Within the holographic recording medium a thick or thin phase hologram is recorded. The holographic recording medium is formed from a photopolymer-dispersed liquid crystal mixture. The photopolymer-dispersed liquid crystal mixture undergoes phase separation during a hologram recording process, creating fringes composed of regions densely populated by liquid crystal microdroplets interspersed within regions of clear photopolymer. The resultant phase volume hologram exhibits a very high diffraction efficiency. However, when an electric field is applied, by way of electrodes coupled to the holographic recording medium, the natural orientation of the liquid crystal droplets changes, causing a reduction in the fringe modulation. As a result, the efficiency of the hologram diffraction pattern drops to a very low level, thereby effectively erasing the hologram. Thus, a switchable holographic optical element may exist in two states. The active state is defined as the state in which the hologram is apparent in the holographic recording medium. The inactive state is the state when the hologram is effectively erased, due to the application of an electric field to the holographic recording medium.

In one embodiment, the front section includes a diffractive element 120 and a reflective element 119. Light from the second section 117 of the optical system is transmitted through the element 120 and is then reflected by the element 119 toward the user's eye A. The element 119 is positioned in front of a window 21 (See FIGS. 41 and 44) in the front housing portion 113, with a shutter 122 being disposed behind the element 119 with respect to the user's eye. Either of these elements, the reflective element 119 and the diffractive element 120 may be formed from a switchable holographic optical element. The other components of optical system may be formed from standard optical components. Examples of standard optical components include, but are not limited to, non-holographic diffraction gratings, lenses, mirrors, Fresnel lenses, and non-switchable holographic diffraction gratings or lenses. Thus, in one embodiment, the diffractive element 120 may be formed using a standard optical component while the reflective element 119 is formed from a switchable holographic optical element. Alternatively, the diffractive element 120 may be formed from a switchable holographic optical element while the reflective element 119 may be formed from a standard optical component. It is noted that the optical components of the optical system other than diffractive element 119 and reflective element 120, may be formed from switchable holographic optical elements. It should be understood, that while the holographic optical elements are depicted as planar elements, curved holographic optical elements may be used. Curved optical elements may facilitate the correction of aberrations and improve the optical efficiency of the system. The formation and use of curved switchable holographic optical elements is described in detail in U.S. patent application Ser. No. 09/416,076 which is incorporated by reference as if set forth herein.

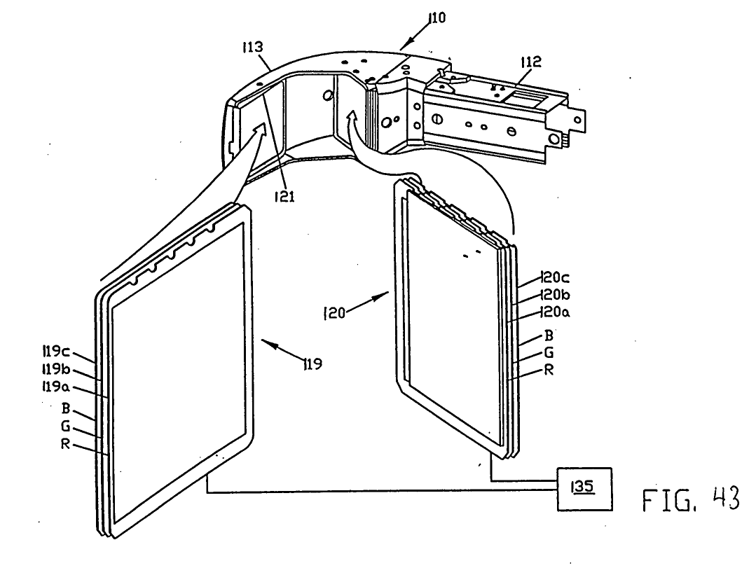

The reflective element 119 may be a reflective switchable holographic diffractive element. A reflective switchable holographic diffractive element includes a holographic recording medium in which a hologram is recorded. For a reflective switchable holographic diffractive element the hologram is of a reflective diffraction grating. The reflective switchable holographic diffractive element as element 119 may mimic the function of a mirror, that is, the reflection of incident light toward the eye of the user. A reflective switchable holographic diffractive element has the ability to operate in both an active and inactive state. In the active state the reflective switchable holographic diffractive element will reflect incident light. In the inactive state the reflective switchable holographic diffractive element will change to a transmissive state, allowing incident light to pass through the element without any substantial reflection. The inactive state may be induced by application of an electric field by electrodes attached to the holographic recording medium. FIG. 43 depicts a reflective switchable holographic diffractive element 119 to which an electrode is attached. The electrode is coupled to a controller 135. The controller is configured to control the application of an electric field to the reflective switchable holographic diffractive element.

The diffractive element 120 may be a transmissive switchable holographic diffractive element. A transmissive switchable holographic diffractive element includes a holographic recording medium in which a hologram is recorded. For a transmissive switchable holographic diffractive element the hologram is of a transmissive diffraction grating. A transmissive switchable holographic diffractive element has the ability to operate in both an active and inactive state. In the active state the transmissive switchable holographic diffractive element will diffract incident light as it passes through the element. In the inactive state, the hologram recorded within the transmissive switchable holographic diffractive element will be effectively erased, allowing incident light to pass through the element without any substantial diffraction. The inactive state may be induced by application of an electric field by electrodes attached to the holographic recording medium, as described above.

In one embodiment, both the reflective element 119 and the diffractive element 120 are composed of switchable holographic optical elements. Reflective element 119 is a reflective switchable holographic diffractive element. Diffractive element 120 is a transmissive switchable holographic diffractive element. The combination of two or more diffractive elements (switchable or non-switchable) allows the high chromatic dispersions and off-axis aberrations generated by each of the diffractive elements to be balanced.

In one embodiment, the image generator is configured to generate color images. Typically, color display devices emit red, blue and green light to produce a color image. In many cases a pixel of a color display device may be composed of three sub-pixels a red sub-pixel, a blue sub-pixel, and a green sub-pixel. Alternatively, a pixel may be configured to sequentially emit red, blue and green colors. The image generator may be based on any transmissive, reflective, diffractive, or self-emissive technology. For example the input image display could be based on an emissive technology such as an electroluminescent panel or a miniature cathode ray tube. It could be also be based on diffractive technology such as the Grating Light Valve manufactured by Silicon Light Machines, Calif.

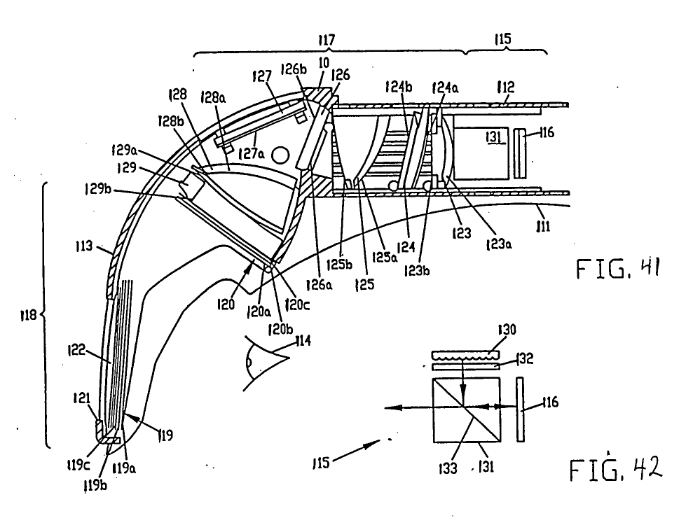

In one embodiment, the image generator includes an array of light emitting diodes (LEDs) 130 disposed above a polarizing beamsplitter cube 131 with an array of Fresnel lenses 131 interposed between the LEDs and the beamsplitter cube, as depicted in FIG. 42. Light from the LEDs 130 is initially collimated by the Fresnel lens array 131, and is then reflected by an interface 133 of the cube 131 towards the display screen 116. The screen 116, in one embodiment, displays a monochromatic image that is illuminated by light from the LEDs 130, and the resultant image is transmitted through the cube interface 133 towards the second section 117 of the optical system. The display screen 116 may take any suitable form, such as a miniature reflective silicon backplane device or an LCD panel.

Although not shown, the image generator 115 also includes a quarter wave plate and a trichromatic interference filter which filters the light from the LEDs 130 into three narrow bandwidths centered respectively on red, green and blue peak wavelengths. In alternative arrangements, the image generator 115 may include integrated optics and/or holographic optical elements. As a further alternative, the image generator may utilize solid state lasers as the light source, which have inherently narrow wavelength emissions and which avoid the need for bandwidth filtering.

FIG. 42 shows the use of a reflective LCD panel in the image generator. I another embodiment, the LCD panel may be illuminated incident off-axis at an incident angle that is sufficiently large for the reflected light beams from the LCD panel to avoid the incident light. Thus the use of a beam splitter cube may no longer be necessary.

In another embodiment, a rear illuminated transmissive LCD panel may be used. Thus the image is generator on an LCD panel and illuminated by a light source positioned behind the LCD panel. In one embodiment, the light source may be provided by remote lasers via a fiber optic cable.

For the transmittal of color images, each of the switchable holographic optical elements 119 and 120 are formed by a stack of three holographic layers, 119a, 119b, and 119c for element 119, 120a, 120b, and 120c for element 120. The three holographic layers may be formed as discrete layers separated by a glass plates. Alternatively, the three holographic layers may be formed within a single holographic recording medium. The following discussion will be applied to only element 119 and holographic layers 119a, 119b, and 119c. However, it should be understood that the holographic layers 120a, 120b, and 120c are configured in an analogous fashion to the holographic layers of element 119, differing only in the holographic images recorded in the layers.

Switchable holographic optical element 119a has a hologram recorded in it that is optimized to diffract red light. Switchable holographic optical element 119b has a hologram recorded in it that is optimized to diffract green light. Switchable holographic optical element 119c has a hologram recorded in it that is optimized to diffract blue light. Each of the switchable holographic optical elements 119a, 119b, and 119c have a set of electrodes configured to apply a variable voltage to each of the switchable holographic optical elements. Since element 119 is a reflective switchable holographic diffraction element, the holograms are optimized for the reflection of the appropriate bandwidth of light.

As described above, an image generator may be configured to generate, sequentially, the red, green, blue components of a color image. In one embodiment, one set of electrodes associated with the emulsions 119a, 119b and 119c is activated at any one time. With the electrodes activated, a selected amount of light is diffracted into the 1st order mode of the hologram and towards a user, while light in the 0th order mode is directed such that the user cannot see the light. The electrodes on each of the three holograms are sequentially activated such that a selected amount of red, green and blue light is directed towards a user. Provided that the rate at which the holograms are sequentially activated is faster than the response time of a human eye, a color image will be created in the viewer's eye due to the integration of the red, green and blue monochrome images created from each of the holograms 119a, 119b, and 119c.

The switching of the holographic optical elements 119a, 119b, and 119c is coordinated with the colors emitted by image generator. When the image generator emits red light, for example, the holographic optical elements associated with green light and blue light (119b and 119c) are inactivated such that the they are substantially transparent to the incident light. The holographic optical element 119a, however, is left in an active state so that the incident red light is diffracted toward the user. Similarly, when green light is emitted by the image generator, holographic optical elements 119a and 119c are inactivated while holographic optical element 119b is in an active state. Finally, when blue light is emitted by the image generator, holographic optical elements 119a and 119b are inactivated while holographic optical elements 119c is in an active state

As noted before, the combination of two or more diffractive elements allows the high chromatic dispersions and off-axis aberrations generated by each of the diffractive elements to be balanced. The use of separate red, green and blue elements is particularly advantageous in this regard because the optical system may be separately optimized for red, green, and blue light. In a conventional color display system which does not include separate diffractive elements for each color, it would be necessary to optimize the optical system for the full visible bandwidth. Such an optimization may be difficult to perform for system which include holographic/diffractive elements

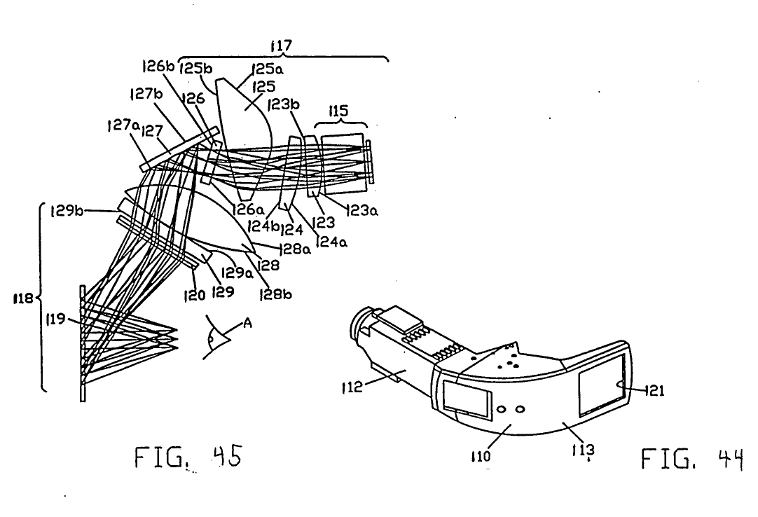

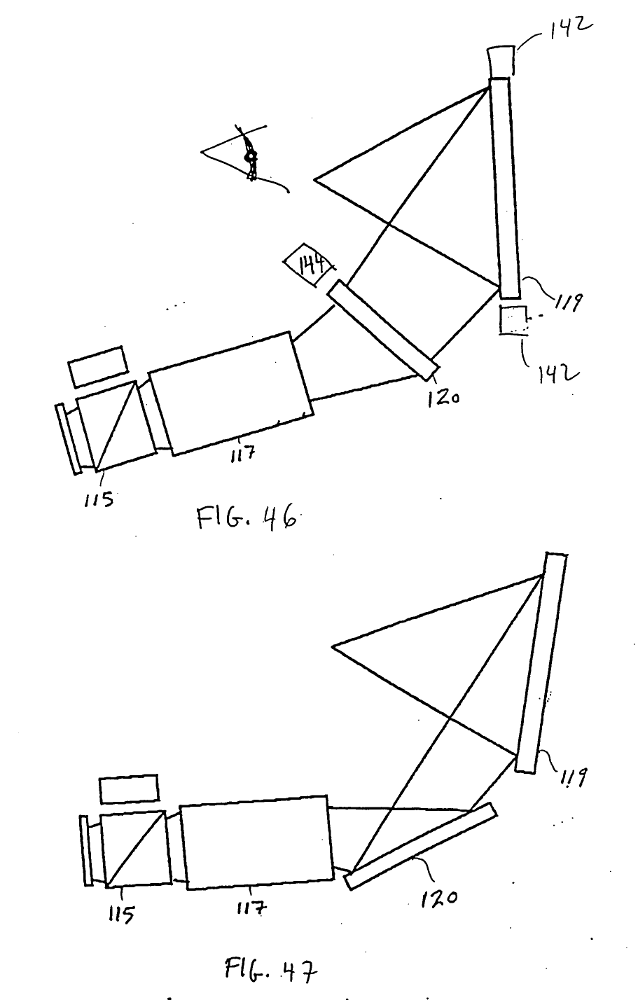

The second portion 117 of the optical system, in one embodiment, includes (in order along the optical path away from the image generator 115) four lens elements 123, 124, 125, and 126, a reflective element (mirror) 127, and two further lens elements 128 and 129. For each of the lens elements the surface facing towards the image generator is designated by the suffix a, while the surface facing away from the image generator is designated by the suffix b. The surface of the mirror 127 is designated by 127a. These optical elements, together, form an optical subsystem for transferring the light produced by the image to the first section. The optical subassembly is also configured to combat aberrations and reduce dispersion of the light as it travels through the second section. It should be understood that, while depicted in FIGS. 41 and 45 as including a specific number of discrete optical elements, the optical subassembly may include more or less optical elements depending on design factors required for a particular application. Also, while many of the components are depicted as standard lenses and mirrors, it should be noted that holographic optical elements (either static or switchable) may be used in the optical subassembly. Additional, other types of standard optical components such as Fresnel lenses may be used.

In the depicted embodiment, the optical subassembly may be divided into three portions, a first condenser system (which includes elements 123, 124, 125, and 126), a reflective element (element 127), and a second condenser system (which includes elements 128 and 129). The first and second condenser systems are optimized using standard optical design techniques to transmit the image light from the input image display source to the reflective element or from the reflective element to the first section, respectively. Both condenser systems incorporate optical elements that help reduce the dispersion of light as the light passes through the system. The optical elements are also designed to reduce chromatic and monochromatic aberrations as the light passes through the second section. Monochromatic aberration include spherical aberrations, coma, astigmatism, field curvature, and geometric distortions.

The above described optical subassembly is configured such that a viewable image will only exist at the input image panel 116 and at the final output of the display. However, in other embodiments an intermediate image may be formed at a diffusing screen positioned at some point along the optical train. The intermediate image may effectively act as a new input image for the elements 119 and 120. This may allow a larger exit pupil to be used.

The combination of holographic elements 119 and 120 is configured to reduce both dispersion of the light and aberrations. Elements 119 and 120 are optimized such that their chromatic and monochromatic aberrations and distortions are compensated. In particular, element 120 has the primary function of “focusing” the light in such a way as to avoid chromatic aberration, while element 119 serves the primary purpose of achieving a desired field of view. However, the high incidence angles involved give rise to off-axis aberrations (particularly astigmatism, geometric distortion and keystoning), the main purpose of the components in the section 117 of the optical system is to correct these aberrations.

One advantage of the currently described system, is that the use of switchable holographic optical elements allows the use of low weight optical elements in the vicinity of the eye. A typical head mounted display system will require a number of optical components in the vicinity of the eye to correct the aberrations caused by transmitting the image from an off-axis position to the eye. Typically, large aperture images are required in the vicinity of the eye to correct aberrations. By using the switchable holographic optical elements, the weight of the apparatus, especially in the vicinity of the eye, may be minimized.

The apparatus may also include a stop to define the limiting aperture. This stop is preferably located at or near the lens element surface 126a (i.e., the centered aspheric surface that is nearest to the mirror 127) and is of elliptical form. The stop may be formed as a separate component added to the system (e.g., a plastic or metal plate having an aperture of the appropriate dimensions) or may be “painted” on the back surface of the element.

The above-described apparatus has several advantages some of which includes compact construction and the reduction of structure located in front of the user's eye, the bulk of its weight being positioned instead to the side of the user's head or, in the case of a top mounted design, upon the upper surface of a user's head. Although this means that the projection optical system is highly off-axis, dispersion and chromatic aberration are minimized by the use of switchable holographic diffraction elements. If conventional optical components were to be used in place of the switchable holographic optical elements, it would be necessary to have additional conventional optical elements such as tilted off-axis aspherical lenses, prismatic elements and cylindrical elements. The additional optical elements which perform the functions of the reflective eye pieces would need to be bigger and therefore heavier.

The apparatus has been described above with reference to one of the user's eyes. In practice, however, a similar apparatus may be provided for the other eye as well, with the respective display screens showing either identical or stereoscopically-paired images. In this case, the housings 110 of both apparatuses may be combined into a unified headset. The unified headset may take on the appearence of a helmet. Alternatively, the unified headset may resemble a pair of glasses.

In addition to viewing images as produced by the image generator 115, the apparatus can also be employed for viewing the ambient surroundings, either with or without the generated image superimposed thereon. A shutter element 122, is placed behind the reflective element 119, in front of the users eye. To view the surroundings, a shutter 122 is switched so that it becomes light-transmitting rather than light-obstructing. In the case where the generated image is not to be viewed at the same time, the holographic diffraction elements 119 and 120 are turned off. Alternatively, the shutter may be opened, while an image is being projected to the user to create an effect in which the image produced by the image generator appears to be superimposed upon the surroundings.

FIG. 46 depicts an embodiment of the optical system of a display apparatus. The optical system includes an image generator 115 an optical subassembly 117 and two diffractive elements 119 and 120. Element 120 is a transmissive element while element 119 is a reflective element. At least one the elements, 119 or 120, is a switchable holographic element. The other element may be any of a variety of standard optical components such as a non-switchable holographic/diffractive, Fresnel, refracting, or reflecting optical element. The transmissive element 120 may be configured such that a virtual image is only produced at the final output of the display. In another embodiment, the element 120 may be a transmissive diffusing screen. The optical subassembly 117 is configured such that a real intermediate is formed at element 120. This real image is transmitted through the screen to the reflective element 119 which forms a final virtual image for the user. Alternatively, the system of FIG. 46 may be configured to produce a directly viewable image. In this alternate embodiment, the reflective element 119 may be a reflective diffusing screen. The final image is then formed on the screen element 119, as opposed to being transmitted to the user as a virtual image.

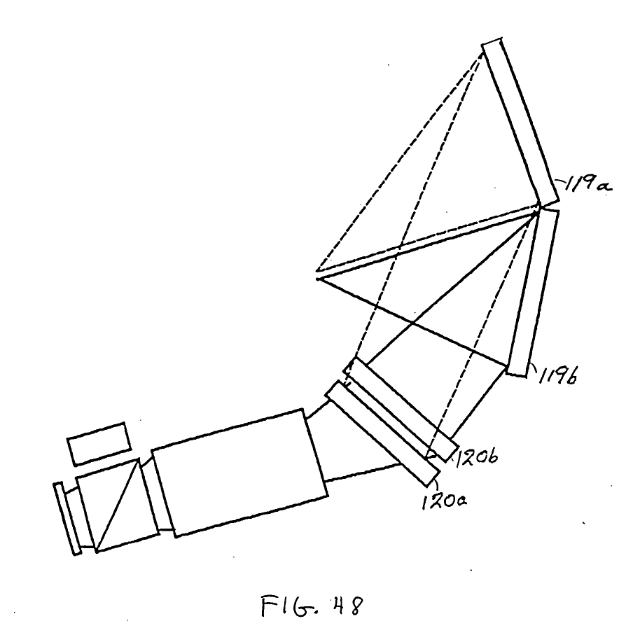

In contrast to the system depicted in FIG. 46, the system of FIG. 47 may include two reflective diffractive elements. Both element 119 and element 120 may be reflective diffractive elements. At least on of the elements, 119 or 120, is a switchable holographic optical element. The other element may be any of a variety of standard optical components such as a non-switchable holographic/diffractive, Fresnel, refracting, or reflecting optical element. The reflective element 120 may be configured such that a virtual image is only produced at the final output of the display. In another embodiment, the element 120 may be a reflective diffusing screen. The optical subassembly 117 is configured such that a real intermediate is formed at element 120. This real image is reflected from the screen to the reflective element 119 which forms a final virtual image for the user. Alternatively, element 119 may be a reflective diffusing screen while element 120 is a reflective switchable holographic diffractive element. The final image is then formed on the screen element 119, as opposed to being transmitted to the user as a virtual image.

In another embodiment, depicted in FIG. 48, switchable holographic optical elements may be used to generate a tiled image by having additional layers in the switchable element 120 to create separate fields of view which can be tiled to give a composite view. To accomplish this the transmissive element may be formed from two stacked transmissive elements 120a and 120b. The reflective element is also formed from two reflective elements 119a and 119b. The reflective elements are configured to direct the incident light toward the user's eye. The transmissive elements are configured to diffract the incident light from one reflective element or the other. The transmissive diffractive elements 120 may be switchable, such that only one element at a time transmits the incident light. By rapidly alternating the two elements between an active and inactive state two distinct images may appear to be superimposed to a user. This method of generating a tiled image is described in U.S. patent application Ser. No. 09/388,944 which is incorporated by reference as if set forth herein.

Alternatively, the apparatus may be used as a combined imaging and display system. Such a system is described in U.S. patent application Ser. No. 09/313,431 which is incorporated by reference as if set forth herein.

The apparatus may also include an eye tracker device which includes a plurality of emitters 142 disposed around the outer periphery of the element 119. The emitters 142 are configured to project radiation in a broad wash onto the eye. The projected radiation is reflected back from the eye and directed to a detector 144. Signals from the detector 144 are processed by a processing system 120 in order to measure changes in the attitude of the eye, and data corresponding to those changes is fed back to the image generator 115. This in turn causes the image generator 115 to alter the image displayed by the apparatus, so that the view seen by the observer move with his or her direction of gaze.

The detector 144 may be a miniature two-dimensional detector array, crossed one-dimensional detector array, or a peak intensity detection device (such as a position sensing detector). Moreover, the various components of the eye tracker device and the wavelength of the radiation used, are chosen such that their characteristics may be optimized to allow particular features of the eye to be easily recognized and tracked.

Optical System Components

The following described optical components were used to form a viewing apparatus as depicted in FIGS. 41-45. While these optical components represent a practical example of the components for an head mountable apparatus for viewing an image, it is to be understood that the invention is not to be limited to the use of the described components, but rather us untended to cover various modifications and equivalent constructions included within the spirit and scope of the invention. It should also be noted that the elements of the optical system, as depicted in FIG. 45, may be truncated such that the unused portion of the optical elements is removed when the element is disposed in the housing. FIG. 41 depicts the same optical components as depicted in FIG. 41, however the unused portions of the lenses have been removed to allow a more streamlined appearance for the housing.

Optical Component 123

Optical component 123 is a spherical/aspherical lens made from an acrylic material. The lens includes two surfaces, surface 123a is oriented towards the image generator, and 123b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 123b is a spherical surface having a concave radius of curvature of 204.375 mm. The surface 123a is a polynomial asphere surface. The surface 123a has a convex radius of curvature of 16.927 mm. The deviation of the surface 123a from a spherical surface along the optical axis (defined as the z axis) of the lens (“Sag (z)”), is defined by the following equation:

Sag(z)=[(1/R)*h²]/[1+sqrt(1−(h/R)²)]+Ah⁴+Bh⁶+Ch⁸

where sqrt( ) represents the square root of the value enclosed within the parenthesis;

h²=x²+y, where x and y equal the Cartesian coordinates along the x and y axis of the lens element;

R=−16.92694

A=0.551681×10⁻⁴

B=0.170580×10⁻⁶

C=0.310160×10⁻⁹

The lens element 123 has a central thickness of 4.624 mm. The edge to edge diameter is 19.800 mm. When mounted within the housing the clear aperture diameter of the mounted lens is 17.4 mm.

Optical Component 124

Optical component 124 is a planar/aspherical lens made from an acrylic material. The lens includes two surfaces, surface 124a is oriented towards the image generator, and 124b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 124b cylindrical along the x axis having a convex radius of curvature of 25.63731 mm. The surface 124a is a polynomial asphere surface. The surface 124a has a convex radius of curvature of 68.952 mm. The deviation of the surface 124a from a spherical surface along the optical axis (defined as the z axis) of the lens (“Sag (z)”), is defined by the following equation:

Sag(z)=[(1/R)*h²]/[1+sqrt(1−(h/R)²)]+Ah⁴+Bh⁶

where sqrt() represents the square root of the value enclosed within the parenthesis;

h²=X²+y², where x and y equal the Cartesian coordinates along the x and y axis of the lens element;

R=−68.95221

A=0.156537×10⁻⁴

B=−0.167323×10⁻⁶

The lens element 124 has a central thickness of 4.461 mm. The edge to edge diameter is 23.000 mm. When mounted within the housing the clear aperture diameter of the mounted lens is 20.600 mm.

Optical Component 125

Optical component 125 is a spherical/aspherical lens made from an acrylic material. The lens includes two surfaces, surface 125a is oriented towards the image generator, and 125b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 125b is a spherical surface having a convex radius of curvature of 138.955 mm. The surface 125a is apolynomial asphere surface. The surface 125a has a convex radius of curvature of 11.813 mm. The deviation of the surface 125a from a spherical surface along the optical axis (defined as the z axis) of the lens (“Sag (z)”), is defined by the following equation:

Sag(z)=[(1/R)*h²]/[1+sqrt(1−(1+K)*(h/R)²)]+Ah⁴+Bh⁶+Ch⁸+Dh¹⁰

where sqrt( ) represents the square root of the value enclosed within the parenthesis;

h²=x²+y², where x and y equal the Cartesian coordinates along the x and y axis of the lens element;

R=−11.81344

K=−1.807381

A=−0.285278×10⁻⁴

B=0.209903×10⁻⁶

C=−0.502354×10⁻⁹

D=0.425282×10⁻¹²

The lens element 125 has a central thickness of 14.000 mm. The edge to edge diameter is 36.800 mm. When mounted within the housing the clear aperture diameter of the mounted lens is 34.400 mm.

Optical Component 126

Optical component 126 is a spherical/aspherical lens made from an acrylic material. The lens includes two surfaces, surface 126a is oriented towards the image generator, and 126b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 126b is a spherical surface having a convex radius of curvature of 101.398 mm. The surface 126a is a polynomial asphere surface. The surface 126a has a convex radius of curvature of 145.335 mm. The deviation of the surface 126a from a spherical surface along the optical axis (defined as the z axis) of the lens (“Sag (z)”), is defined by the following equation:

Sag(z)=[(1/R)*h²]/[1+sqrt(1−(h/R)²)]+Ah⁴+Bh⁶+Ch⁸

where sqrt( ) represents the square root of the value enclosed within the parenthesis;

h²x²+y², where x and y equal the Cartesian coordinates along the x and y axis of the lens element;

R=101.39766

A=−0.351519×10⁻⁴

B=−0.501521×10⁻⁶

C=0.363217×10⁻⁸

The lens element 126 has a central thickness of 3.000 mm. The edge to edge diameter is 13.800 mm. When mounted within the housing the clear aperture diameter of the mounted lens is 11.4 mm.

Optical Component 127

Optical component 127 is a plano/cylindrical mirror made from glass. The mirror includes two surfaces, surface 127a is oriented towards the image generator, and 127b which is the surface oriented away from the image generator (See FIG. 41). The surface 127a is a planar surface. Surface 127a is coated with a high-reflection coating having a maximum reflectance over 460-628 nm. The surface 127b is cylindrical along the x axis having a convex radius of curvature of 69.000 mm. The mirror 127 has a central thickness of 4.000 mm. The edge to edge diameter is 26.000 mm. When mounted within the housing the clear aperture diameter of the mounted mirror is 23.600 mm.

Optical Component 128

Optical component 128 is a spherical/aspherical lens made from an acrylic material. The lens includes two surfaces, surface 128a is oriented towards the image generator, and 128b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 128b is a spherical surface having a convex radius of curvature of 60.612 mm. The surface 128a is a polynomial asphere surface. The surface 128a has a convex radius of curvature of 25.510 mm. The deviation of the surface 128a from a spherical surface along the optical axis (defined as the z axis) of the lens (“Sag (z)”), is defined by the following equation:

Sag(z)[(1/R)*h²]/[1+sqrt(1−(h/R)²)]+Ah⁴+Bh⁶+Ch⁸

where sqrt( ), represents the square root of the value enclosed within the parenthesis;

h²=x²+y², where x and y equal the Cartesian coordinates along the x and y axis of the lens element;

R=25.51037

A=−0.155134×10⁻⁴

B=0.288638×10⁻⁶

C=−0.569516×10⁻⁸

The lens element 128 has a central thickness of 13.365 mm. The edge to edge diameter is 43.000 mm. When mounted within the housing the clear aperture diameter of the mounted lens is 40.600 mm.

Optical Component 129

Optical component 129 is a cylindrical/asphere lens made from an acrylic material. The lens includes two surfaces, surface 129a is oriented towards the image generator, and 129b which is the surface oriented away from the image generator (See FIG. 41). The acrylic material used to form the lens has the following refractive indices at the listed wavelengths:

n(656.27 nm)=1.488394±0.0006

n(587.56 nm)=1.491002±0.0006

n(486.13 nm)=1.496978±0.0006

The surface 129b is cylindrical along the x axis having a convex radius of curvature of 47.13109 mm. The surface 129a is a polynomial asphere surface. The surface 129a has a concave radius of curvature of 54.966 mm. The deviation of the surface 129a from a spherical surface along the optical axis (defined as the z axis) of the lens (“Sag (z)”), is defined by the following equation:

Sag(z)=[(1/R)*h²]/[1+sqrt(1−(h/R)²)]+Ah⁴+Bh⁶+Ch⁸

where sqrt( ) represents the square root of the value enclosed within the parenthesis;

h²=x²+y, where x and y equal the Cartesian coordinates along the x and y axis of the lens element;

R=−54.96615

A=0.215568×10⁻⁴

B=−0.108402×10⁻⁷

C=0.280821×10⁻¹⁰

The lens element 129 has a central thickness of 3.000 mm. The edge to edge diameter is 31.600 mm. When mounted within the housing the clear aperture diameter of the mounted lens is 29.2 mm.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. An apparatus comprising:
an image generator for generating an image;
an optical system configured to transmit light of the image to an eye of a user, the optical system comprising a first switchable holographic optical element configured to operate in an active state or an inactive state, wherein the first switchable holographic optical element is configured to diffract the image light incident thereon when the first switchable holographic optical element operates in the active state, and wherein the first switchable holographic optical element transmits the image light incident thereon without substantial alteration when the first switchable holographic optical element operates in the inactive state;
a control circuit coupled to the first switchable holographic optical element, wherein the control circuit is configured to generate a first control signal, wherein the first holographic optical element operates between the active and inactive states according to the control signal generated by the control circuit;
a headset comprising a housing, the housing arranged to be positioned near a temple region of the user's head when the user wears the headset, wherein the image generator, the first control circuit and the first switchable holographic optical element are disposed within the housing.

2. The apparatus of claim 1 wherein the image generator is positioned off-axis from a general direction of view of the user's eye when the user wears the headset.

3. The apparatus of claim 1 wherein diffraction of the image light is variable from one point or spatial region in the first switchable holographic optical element to another.

4. The apparatus of claim 1:
wherein the image light comprises first, second, and third image light;
wherein the optical system further comprises;
a second switchable holographic optical element configured to operate in an active state or an inactive state, wherein the second switchable holographic optical element is configured to diffract second bandwidth image light when the second switchable holographic optical element operates in the active state, and wherein the second switchable holographic optical element transmits second bandwidth image light without substantial alteration when the second switchable holographic optical element operates in the inactive state;
a third switchable holographic optical element configured to operate in an active state or an inactive state, wherein the third switchable holographic optical element is configured to diffract third bandwidth image light when the third switchable holographic optical element operates in the active state, and wherein the third switchable holographic optical element transmits third bandwidth image light without substantial alteration when the third switchable holographic optical element operates in the inactive state;
wherein the first switchable holographic optical element is configured to diffract first bandwidth image light when the first switchable holographic optical element operates in the active state, and wherein the first switchable holographic optical element transmits third bandwidth image light without substantial alteration when the first switchable holographic optical element operates in the inactive state;
wherein the second and third switchable holographic optical elements are disposed within the housing.

5. The apparatus of claim 1 wherein the optical system operates sequentially to transmit diffracted image light of different colors to the user's eye.

6. The apparatus of claim 4 wherein the optical system further comprises:
a fourth switchable holographic optical element is configured to diffract first bandwidth image light when the fourth switchable holographic optical element operates in the active state, and wherein the fourth switchable holographic optical element transmits first bandwidth image light without substantial alteration when the fourth switchable holographic optical element operates in the inactive state;
a fifth switchable holographic optical element configured to operate in an active state or an inactive state, wherein the fifth switchable holographic optical element is configured to diffract second bandwidth image light when the fifth switchable holographic optical element operates in the active state, and wherein the fifth switchable holographic optical element transmits second bandwidth image light without substantial alteration when the fifth switchable holographic optical element operates in the inactive state;
a sixth switchable holographic optical element configured to operate in an active state or an inactive state, wherein the sixth switchable holographic optical element is configured to diffract third image light when the sixth switchable holographic optical element operates in the active state, and wherein the sixth switchable holographic optical element transmits third bandwidth image light without substantial alteration when the sixth switchable holographic optical element operates in the inactive state;
wherein each of the fourth, fifth and sixth switchable holographic optical elements comprise a first surface, wherein each of the fourth, fifth and sixth switchable holographic optical elements is configured to diffract image light received on the first surface thereof, wherein image light diffracted by the fourth switchable holographic optical element emerges from the first surface thereof, wherein image light diffracted by the fifth switchable holographic optical element emerges from the first surface thereof, and wherein image light diffracted by the sixth switchable holographic optical element emerges from the first surface thereof;
wherein the fourth, fifth, and sixth switchable holographic optical elements are attached to the headset and positioned adjacent the user's eye when the headset is worn by the user.

7. The apparatus of claim 1 wherein the first holographic optical element functions to correct aberrations and/or distortions in image light received from the image generator.

8. The apparatus of claim 6:
wherein the first bandwidth image light diffracted by the first holographic optical element includes image aberrations caused by the first holographic optical element;
wherein the fourth holographic optical element, when operating in the active state, corrects the image aberrations in the diffracted first bandwidth light when the fourth holographic optical element operates in the active state;
wherein the second bandwidth image light diffracted by the second holographic optical element includes image aberrations caused by the second holographic optical element;
wherein the fifth holographic optical element, when operating in the active state, corrects the image aberrations in the diffracted second bandwidth light when the fifth holographic optical element operates in the active state;
wherein the third bandwidth image light diffracted by the third holographic optical element includes image aberrations caused by the third holographic optical element;
wherein the sixth holographic optical element, when operating in the active state, corrects the image aberrations in the diffracted third bandwidth light when the sixth holographic optical element operates in the active state.

9. The apparatus of claim 1 wherein the image generator comprises a light source and a display screen, and wherein the light source is positioned such that light generated from the light source illuminates the image formed on the display screen.

10. The apparatus of claim 1 wherein the headset is a helmet.

11. An apparatus comprising:
first and second image generators for generating image light;
first and second optical systems configured to transmit image light from the first and second image generators, respectively, to left and right eyes of a user, the first and second optical systems comprising first switchable and second holographic optical elements, respectively, each of which is configured to operate in an active state or an inactive state, wherein the first and second switchable holographic optical elements are configured to diffract image light incident thereon when the first and second switchable holographic optical elements operate in the active state, and wherein the first and second switchable holographic optical elements transmit image light incident thereon without substantial alteration when the first and second switchable holographic optical elements operate in the inactive state;
a headset comprising first and second housings, the first and second housings arranged to be positioned near left and right temple regions of the user's head when the user wears the headset, wherein the first and second image generators are disposed in the first and second housings, respectively, and wherein the first and second switchable holographic optical elements are disposed within the first and second housings, respectively.

12. The apparatus of claim 11 wherein the first and second image generators are positioned off-axis from a general direction of view of the user's left and right eyes, respectively, when the user wears the headset.

13. The apparatus of claim 11 wherein diffraction of the image light is variable from one point or spatial region in the first switchable holographic optical element to another.

14. The apparatus of claim 11 wherein the optical system operates sequentially to transmit diffracted image light of different colors to the user's eye.
